(19) United States
(12) Patent Application Publication
(10) Pub. No.: US 2024/0001501 A1
(43) Pub. Date: Jan. 4, 2024

(54) ELECTRIC POWER TOOLS WITH SAFETY BRAKES THAT INCLUDE IMPULSE SOLENOIDS AND METHODS OF OPERATING THE ELECTRIC POWER TOOLS

(71) Applicant: Festool GmbH, Wendlingen (DE)

(72) Inventors: Dominik Olivotto, Ostfildern-Nellingen (DE); Manuel Bäuerle, Filderstadt (DE)

(73) Assignee: Festool GmbH, Wendlingen (DE)

(21) Appl. No.: 18/253,150

(22) PCT Filed: Nov. 16, 2021
(86) PCT No.: PCT/EP2021/081872

§ 371 Date: May 16, 2023

Related U.S. Application Data
(60) Provisional application No. 63/114,819, filed on Nov. 17, 2020.

(51) Int. Cl. B23Q 11/00; H01F 7/06; H01F 7/16; F16D 65/18; F16D 63/00; F16D 59/00; F16D 55/224

(52) U.S. Cl. CPC B23Q 11/0092; H01F 7/064; H01F 7/1607; F16D 65/18; F16D 63/002; F16D 59/00; F16D 55/224; B27G 19/02

(57) ABSTRACT

Electric power tools with safety brakes that include impulse solenoids and methods of operating the electric power tools. The electric power tools include an implement holder configured to hold an implement, which is configured to perform an operation on a workpiece. The electric power tools also include a motor, which is configured to actuate the implement holder to move the implement, and a safety brake. The safety brake includes a brake assembly configured to be transitioned between a disengaged configuration, in which the brake assembly permits motion of the implement, and an engaged configuration, in which the brake assembly resists motion of the implement. The safety brake also includes an actuator assembly configured to selectively provide a motive force to transition the brake assembly from the disengaged configuration to the engaged configuration. The actuator assembly includes an impulse solenoid and solenoid drive circuitry.

### RELATED APPLICATION

This application claims priority to U.S. Provisional Patent Application No. 63/114,819, which was filed on Nov. 17, 2020, and the complete disclosure of which is hereby incorporated by reference.

### FIELD OF THE DISCLOSURE

The present disclosure relates generally to electric power tools with safety brakes that include impulse solenoids and to methods of operating the electric power tools.

### BACKGROUND OF THE DISCLOSURE

Power tools utilize an implement to perform an operation on a workpiece. The implement may be sharp and can, in some instances, represent a safety hazard to a user of the power tool. Many power tools include guards and/or other mechanisms to protect the user from contact with the implement. However, it still may be desirable to have secondary and/or additional safety mechanisms in place. Some such secondary and/or additional safety mechanisms have been developed; however, they generally are one-time-use safety mechanisms and/or require high voltages to operate. It may be desired to implement multi-use and/or lower-voltage safety mechanisms. Thus, there exists a need for improved actuator assemblies for braking electric power tools, for braking assemblies that include the actuator assemblies, and for power tools that include the braking assemblies.

### SUMMARY OF THE DISCLOSURE

Electric power tools with safety brakes that include impulse solenoids and methods of operating the electric power tools. The electric power tools include an implement holder configured to hold an implement, which is configured to perform an operation on a workpiece. The electric power tools also include a motor, which is configured to actuate the implement holder to move the implement, and a safety brake. The safety brake includes a brake assembly configured to be transitioned between a disengaged configuration, in which the brake assembly permits motion of the implement, and an engaged configuration, in which the brake assembly resists motion of the implement. The safety brake also includes an actuator assembly configured to selectively provide a motive force to transition the brake assembly from the disengaged configuration to the engaged configuration. The actuator assembly includes an impulse solenoid and solenoid drive circuitry. The impulse solenoid is configured to be selectively transitioned from an unactuated state to an actuated state responsive to receipt of an electrical impulse signal and to provide the motive force while transitioning from the unactuated state to the actuated state. The solenoid drive circuitry is configured to selectively generate the electrical impulse signal. The electrical impulse signal has an impulse voltage of at most 43 volts (V) and an impulse duration of at most 10 milliseconds (ms) and is configured to transition the impulse solenoid from the unactuated state to the actuated state in a transition time of at most 15 milliseconds.

The methods include applying an electric current to a motor of the electric power tool and, responsive to the applying, moving an implement of the electric power tool. During the moving, the methods also include detecting an actuation parameter indicative of an undesired event to be avoided with the electric power tool. The methods further include transitioning a safety brake of the electric power tool from a disengaged configuration, in which the safety brake permits motion of the implement, to an engaged configuration, in which the safety brake resists motion of the implement. The safety brake includes an actuator assembly configured to selectively provide a motive force for the transitioning. The actuator assembly includes an impulse solenoid and solenoid drive circuitry. The impulse solenoid is configured to be selectively transitioned from an unactuated state to an actuated state responsive to receipt of an electrical impulse signal and to provide the motive force while transitioning from the unactuated state to the actuated state. The solenoid drive circuitry is configured to selectively generate the electrical impulse signal responsive to detection of the actuation parameter, and the transitioning includes providing the electrical impulse signal to the impulse solenoid to transition the impulse solenoid from the unactuated state to the actuated state. The electrical impulse signal has an impulse voltage of at most 43 volts and an impulse duration of at most 10 milliseconds, and the electrical impulse signal is configured to transition the impulse solenoid from the unactuated state to the actuated state in a transition time of at most 15 milliseconds.

### BRIEF DESCRIPTION OF THE DRAWINGS

FIG. 1 is a schematic illustration of examples of actuator assemblies that may be utilized with a brake assembly and/or with a power tool, according to the present disclosure, and illustrates the actuator assembly in an unactuated state.

FIG. 2 is a schematic illustration of the actuator assemblies of FIG. 1 illustrated in an actuated state.

FIG. 3 is a less schematic illustration of an example of an actuator assembly that may be utilized with a brake assembly and/or with a power tool, according to the present disclosure, and illustrates the actuator assembly in an unactuated state.

FIG. 4 is a plot illustrating magnetomotive force that may be generated by an impulse solenoid according to the present disclosure.

FIG. 5 is a more detailed illustration of an example of solenoid drive circuitry that may form a portion of actuator assemblies, according to the present disclosure.

FIG. 6 is a schematic illustration of examples of power tools that may include actuator assemblies, according to the present disclosure.

FIG. 7 is a more detailed schematic illustration of examples of power tools that may include actuator assemblies, according to the present disclosure, and illustrates the actuator assemblies in an unactuated state.

FIG. 8 is a more detailed schematic illustration of examples of power tools that may include actuator assemblies, according to the present disclosure, and illustrates the actuator assemblies in an actuated state.

FIG. 9 is another illustration of examples of power tools that may include actuator assemblies, according to the present disclosure, and illustrates the actuator assembly in an unactuated state.

FIG. 10 illustrates the power tool of FIG. 9 with the actuator assembly in an intermediate state.

FIG. 11 illustrates the power tool of FIGS. 9-10 with the actuator assembly in an actuated state.

FIG. 12 is yet another illustration of an example of a power tool that may include an actuator assembly, according to the present disclosure.

FIG. 13 is a flowchart depicting examples of methods of operating an electric power tool, according to the present disclosure.

### DETAILED DESCRIPTION AND BEST MODE OF THE DISCLOSURE

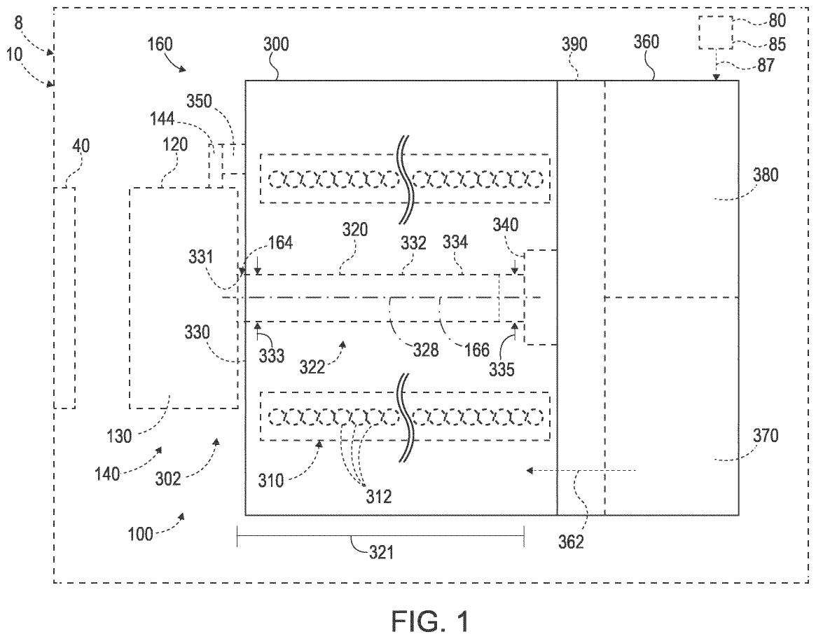

FIGS. 1-13 provide examples of actuator assemblies 160, of brake assemblies 120 that include the actuator assemblies, of power tools 8 that include the brake assemblies, and/or of methods 500, according to the present disclosure. Elements that serve a similar, or at least substantially similar, purpose are labeled with like numbers in each of FIGS. 1-13, and these elements may not be discussed in detail herein with reference to each of FIGS. 1-13. Similarly, all elements may not be labeled in each of FIGS. 1-13, but reference numerals associated therewith may be utilized herein for consistency. Elements, components, and/or features that are discussed herein with reference to one or more of FIGS. 1-13 may be included in and/or utilized with any of FIGS. 1-13 without departing from the scope of the present disclosure.

In general, elements that are likely to be included in a particular embodiment are illustrated in solid lines, while elements that are optional are illustrated in dashed lines. However, elements that are shown in solid lines may not be essential to all embodiments and, in some embodiments, may be omitted without departing from the scope of the present disclosure.

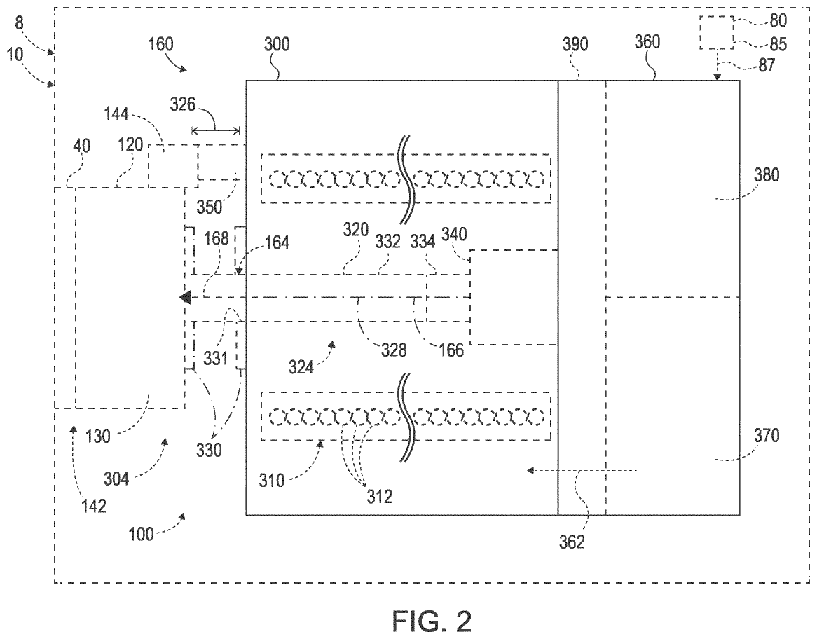

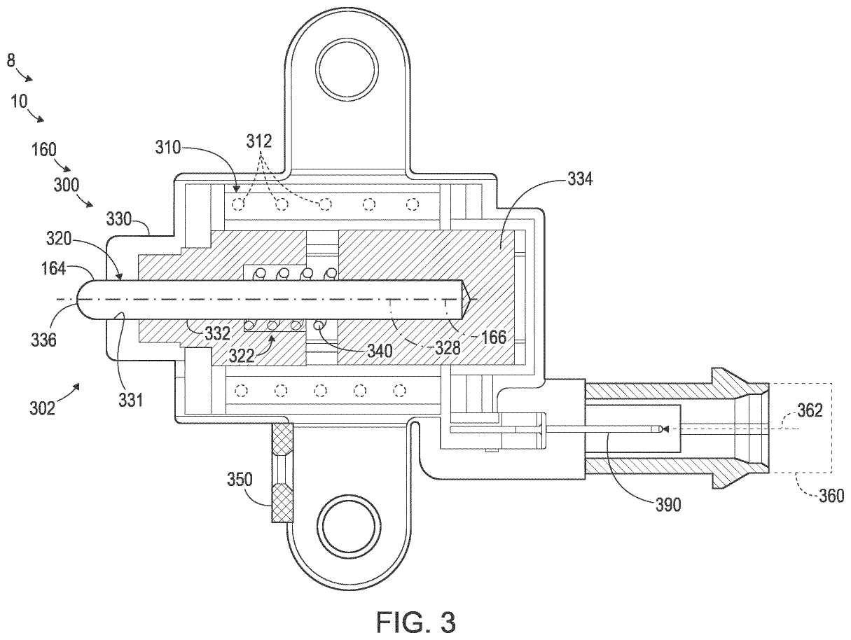

FIG. 1 is a schematic illustration of examples of actuator assemblies 160 that may be utilized with a safety brake 100 and/or with a power tool 8, according to the present disclosure, and illustrates the actuator assembly in an unactuated state 302. FIG. 2 is a schematic illustration of actuator assemblies 160 of FIG. 1 illustrated in an actuated state 304. FIG. 3 is a less schematic illustration of an example of an actuator assembly 160 that may be utilized with a brake assembly 120 and/or with a power tool 8, according to the present disclosure, and illustrates the actuator assembly in an unactuated state 302.

As illustrated in FIGS. 1-3, actuator assemblies 160 include an impulse solenoid 300 and solenoid drive circuitry 360. Impulse solenoid 300 is configured to be selectively transitioned from unactuated state 302, as illustrated in FIGS. 1 and 3, to actuated state 304, as illustrated in FIG. 2, responsive to receipt of an electrical impulse signal 362. Impulse solenoid 300 also is configured to provide a motive force 168, as schematically illustrated in FIG. 2, for actuation of a brake assembly 120 while, upon, and/or responsive to transitioning from unactuated state 302 to actuated state 304.

Solenoid drive circuitry 360 is configured to selectively generate the electrical impulse signal. The electrical impulse signal has an impulse voltage and an impulse duration. The impulse voltage and the impulse duration are sufficient to transition the impulse solenoid from the unactuated state to the actuated state within a threshold transition time. Examples of the impulse voltage include impulse voltages of at least 10 volts (V), at least 15 V, at least 20 V, at least 25 V, at least 30 V, at least 35 V, at least 40 V, at most 42 V, at most 41 V, at most 40 V, at most 38 V, at most 36 V, at most 34 V, at most 32 V, and/or at most 30 V. More specific examples of the impulse voltage include impulse voltages that are equal to 42.4 V, at least substantially equal to 42.4 V, and/or at most 42.4 V. Impulse voltages within these ranges may decrease a potential for electric shock to the user and/or may be readily obtainable from battery powered power tools that operate at common battery voltages. Additionally or alternatively, impulse voltages within these ranges may be sufficiently low to permit power tools 8 to be constructed without additional electrical insulation, which may be needed for higher impulse voltages, thereby decreasing cost, complexity, size, and/or weight of power tools 8.

Examples of the impulse duration include impulse durations of at least 0.25 milliseconds (ms), at least 0.5 ms, at least 0.75 ms, at least 1.0 ms, at least 1.5 ms, at least 2.0 ms, at least 2.5 ms, at least 3.0 ms, at least 3.5 ms, at least 4.0 ms, at least 4.5 ms, at least 5.0 ms, at least 5.5 ms, at least 6.0 ms, at least 6.5 ms, at least 7.0 ms, at least 7.5 ms, at least 8.0 ms, at most 9 ms, at most 8.5 ms, at most 8.0 ms, at most 7.5 ms, at most 7.0 ms, at most 6.5 ms, at most 6.0 ms, at most 5.5 ms, at most 5.0 ms, at most 4.5 ms, at most 4.0 ms, at most 3.5 ms, at most 3.0 ms, at most 2.5 ms, and/or at most 2.0 ms. Impulse durations within these ranges may be sufficient to transition the impulse solenoid from unactuated state 302 to actuated state 304 without overheating the impulse solenoid.

Examples of the threshold transition time include transition times of at least 1 ms, at least 2 ms, at least 4 ms, at least 6 ms, at least 8 ms, at least 10 ms, at most 30 ms, at most 25 ms, at most 20 ms, at most 19 ms, at most 18 ms, at most 17 ms, at most 16 ms, at most 15 ms, at most 14 ms, at most 13 ms, at most 12 ms, at most 11 ms, and/or at most 10 ms. These threshold transition times may be sufficiently small to permit the power tool to cease actuation of the implement prior to, or prior to significant, damage and/or injury should the implement contact the user.

As discussed in more detail herein, and as illustrated in FIGS. 1-2, power tools 8 may include an implement 40, which may be configured to perform an operation on a workpiece. As also discussed in more detail herein, implement 40 may move, may be sharp, and/or may represent a potential safety hazard to a user of the power tool, such as if the user contacts the moving implement. With this in mind, actuator assembly 160 may be configured to selectively and operatively engage brake assembly 120 of safety brake 100, such as to cease and/or to stop motion of the implement. In some examples, this may include selective and operative engagement of the brake assembly with, or into contact with, implement 40. This may protect the user of the power tools from an unsafe condition that may be detected by the power tool and is illustrated by the transition from unactuated state 302, which is illustrated in FIGS. 1 and 3, to actuated state 304, which is illustrated in FIG. 2.

In some examples of power tools 8 that include actuator assembly 160, the actuator assembly may be configured to produce, to generate, and/or to initiate a chain reaction of and/or within brake assembly 120. Stated another way, actuator assembly 160 may be configured to initiate motion within brake assembly 120, with another component of the power tool also providing a portion of the motive force that is utilized to cease actuation of the implement. As an example, brake assembly 120 may include a brake assembly biasing mechanism, such as a spring, that may be released by actuator assembly 160, with the brake assembly biasing mechanism then being utilized to provide a motive force to cease actuation of the implement. As additional examples, brake assembly 120 may include a preloaded and/or a pre-tensioned assembly, such as a lever and/or a clutch, that may be released by actuator assembly 160, with the pre-tensioned assembly then being utilized to provide a motive force to cease actuation of the implement.

In a specific example, and as discussed in more detail herein, brake assembly 120 may include a brake cam 130 that may operatively engage implement 40. In some such examples, actuator assembly 160 may be utilized to urge or move the brake cam into contact with the implement, and motion of the implement may provide a motive force for additional engagement between the implement and the cam, with this additional engagement resisting and/or ceasing further motion of the implement.

Responsive to receipt of electrical impulse signal 362, impulse solenoid 300 may be configured to generate a magnetomotive force, which may produce, may generate, may be proportional to, and/or may be motive force 168 that is illustrated schematically in FIG. 2. Stated another way, the magnetomotive force may cause the impulse solenoid to transition from unactuated state 302 of FIGS. 1 and 3 to actuated state 304 of FIG. 2. Examples of the magnetomotive force include magnetomotive forces of at least 5,000 Ampere-turn (A t or Aw), at least 6,000 A t, at least 7,000 A t, at least 7,500 A t, at least 10,000 A t, at least 12,500 A t, at most 20,000 A t, at most 19,000 A t, at most 18,000 A t, at most 17,000 A t, at most 16,000 A t, at most 15,000 A t, at most 14,000 A t, at most 13,000 A t, at most 12,000 A t, at most 11,000 A t, and/or at most 10,000 A t. Magnetomotive forces in these ranges may be sufficient to permit the impulse coil to reliably actuate brake assembly 120.

Impulse solenoid 300 may include any suitable structure that may be adapted, configured, designed, and/or constructed to selectively transition, or to be selectively transitioned, from unactuated state 302 of FIGS. 1 and 3 to actuated state 304 of FIG. 2 responsive to receipt of the electrical impulse signal. Additionally or alternatively, impulse solenoid 300 may include any suitable structure that may be adapted, configured, designed, and/or constructed to apply, or to selectively apply, motive force 168 to brake assembly 120, to operate at the impulse voltage, to receive the impulse voltage for the impulse duration, and/or to transition from the unactuated state to the actuated state within the threshold transition time.

As an example, and as illustrated in dashed lines in FIGS. 1-2 and in solid lines in FIG. 3, impulse solenoid 300 may include an impulse coil 310. Impulse coil 310, when present, may be configured to receive electrical impulse signal 362, to generate the magnetomotive force, and/or to generate a magnetic field responsive to receipt of the electrical impulse signal. In some examples, impulse coil 310 may include a wound wire 312. Wound wire 312 also may be referred to herein as a plurality of wraps of wire. At least a region of wound wire 312 may include and/or be a helically wound wire and/or a helically wound region. Examples of wound wire 312 include an electrically conductive wire, a metallic wire, an aluminum wire, and/or a copper wire.

As another example, impulse solenoid 300 may include a solenoid armature 320. Solenoid armature 320 also may be referred to herein as, may be, and/or may be operatively attached to an actuator arm 164 of actuator assembly 160. Actuator arm 164 may operatively link actuator assembly 160 with brake assembly 120.

Solenoid armature 320 may be configured to operatively translate between an unactuated position 322, as illustrated in FIGS. 1 and 3, and an actuated position 324, as illustrated in FIG. 2, as the impulse solenoid transitions between unactuated state 302 and actuated state 304. Solenoid armature 320 may have and/or define an elongate axis 328 and may be configured to linearly translate along the elongate axis as the impulse solenoid transitions between the unactuated state and the actuated state. Elongate axis 328 also may be referred to herein as an actuation axis 166 of actuator assembly 160. As illustrated in FIGS. 1-2, solenoid armature 320 may be configured to operatively engage, or engage with, brake assembly 120 to selectively apply motive force 168 to the brake assembly. Additionally or alternatively, solenoid armature 320 may be configured to receive the magnetomotive force from impulse coil 310 and to selectively apply motive force 168 to the brake assembly responsive to receipt of the magnetomotive force.

Solenoid armature 320 may include any suitable component and/or combination of components. As an example, and as illustrated in dashed lines in FIGS. 1-2 and in solid lines in FIG. 3, solenoid armature 320 may include a pin 332 and an anchor 334, which is operatively attached to the pin. Anchor 334, when present, may have a larger anchor diameter compared to a pin diameter of pin 332, thereby permitting and/or facilitating improved alignment of solenoid armature 320 within impulse solenoid 300, decreasing wear due to motion of the solenoid armature within the impulse solenoid, and/or increasing a service life of the impulse solenoid. As perhaps best illustrated in FIG. 3, pin 332 may include and/or define a rounded, a partially spherical, and/or a hemispherical pin end 336, which may be configured to engage with, to operatively engage with, and/or to directly engage with brake assembly 120 of FIGS. 1-2.

In some examples, and as also illustrated in dashed lines in FIGS. 1-2 and in solid lines in FIG. 3, impulse solenoid 300 may include a cap 330, which also may be referred to herein as a dust cap 330. Cap 330, when present, may be configured to decrease a potential for entrance of foreign material and/or dust into the impulse solenoid. In some examples, and as illustrated in dash-dot lines in FIG. 2, cap 330 may form a portion of solenoid armature 320 and/or may be configured to move with the solenoid armature. In other examples, as illustrated in dashed lines in FIGS. 1-2 and in solid lines in FIG. 3, cap 330 may include a central bore 331 through which solenoid armature may move and/or actuate.

Solenoid armature 320 may have and/or define any suitable dimension and/or dimensions. As an example, solenoid armature 320 may define an armature length, or an overall armature length, 321, as illustrated in FIG. 1. Examples of length 321 include lengths of at least 25 millimeters (mm), at least 30 mm, at least 35 mm, at least 40 mm, at least 45 mm, at least 50 mm, at most 70 mm, at most 65 mm, at most 60 mm, at most 55 mm, at most 50 mm, at most 45 mm, and/or at most 40 mm.

As another example, pin 332, when present, may define a pin diameter 333, as also illustrated in FIG. 1. Examples of pin diameter 333 include pin diameters of at least 2 mm, at least 2.5 mm, at least 3 mm, at least 3.5 mm, at least 4 mm, at least 4.5 mm, at least 5 mm, at most 7 mm, at most 6.5 mm, at most 6 mm, at most 5.5 mm, at most 5 mm, at most 4.5 mm, at most 4 mm, at most 3.5 mm, and/or at most 3 mm.

As yet another example, anchor 334, when present, may define an anchor diameter 335, as also illustrated in FIG. 1. Examples of anchor diameter 335 include anchor diameters of at least 10 mm, at least 10.5 mm, at least 11 mm, at least 11.5 mm, at least 12 mm, at least 12.5 mm, at least 13 mm, at least 13.5 mm, at least 14 mm, at most 17 mm, at most 16.5 mm, at most 16 mm, at most 15.5 mm, at most 15 mm, at most 14.5 mm, at most 14 mm, at most 13.5 mm, at most 13 mm, at most 12.5 mm, and/or at most 12 mm.

Solenoid armature 320 may be relatively small and/or may have a relatively small armature mass. Such a small armature mass may decrease a transition time between unactuated position 322 and actuated position 324 and/or may permit and/or facilitate the transition of impulse solenoid 300 from unactuated state 302 to actuated state 304 within the threshold transition time. Stated another way, the small armature mass may permit impulse solenoid 300 to transition from unactuated state 302 to actuated state 304 more quickly when compared to conventional solenoids that include larger, or more massive, conventional armatures. Examples of the armature mass include masses of at least 1 gram (g), at least 2 g, at least 3 g, at least 4 g, at least 5 g, at least 6 g, at least 7 g, at least 8 g, at least 9 g, at least 10 g, at least 12 g, at least 14 g, at least 16 g, at least 18 g, at least 20 g, at least 25 g, at most 40 g, at most 38 g, at most 36 g, at most 34 g, at most 32 g, at most 30 g, at most 28 g, at most 26 g, at most 24 g, at most 22 g, at most 20 g, at most 18 g, at most 16 g, at most 14 g, at most 12 g, at most 10 g, and/or at most 8 g. These relatively small armature masses may decrease an inertia of solenoid armature 320, may permit rapid acceleration of the solenoid armature, and/or may permit and/or facilitate transition of brake assembly 120 from disengaged configuration 140 to engaged configuration 142 within the threshold transition time.

As illustrated by the transition from unactuated state 302 of FIG. 1 to actuated state 304 of FIG. 2, and as indicated in FIG. 2, solenoid armature 320 may have and/or define an armature range of motion 326. Armature range of motion 326 may be defined as a magnitude of motion between unactuated position 322 of FIG. 1 and actuated position 324 of FIG. 2, and armature range of motion 326 may have any suitable value and/or magnitude. Examples of armature range of motion 326 include distances of at least 0.5 millimeters (mm), at least 1.0 mm, at least 1.5 mm, at least 2.0 mm, at least 2.5 mm, at least 3 mm, at least 3.5 mm, at least 4.0 mm, at most 10 mm, at most 9.0 mm, at most 8.0 mm, at most 7.0 mm, at most 6.0 mm, at most 5.5 mm, at most 5.0 mm, at most 4.5 mm, at most 4.0 mm, at most 3.5 mm, at most 3.0 mm, at most 2.5 mm, and/or at most 2.0 mm. These armature ranges of motion may be sufficient to permit impulse solenoid 300 to transition brake assembly 120 from disengaged configuration 140 to engaged configuration 142 within the threshold transition time.

As illustrated in dashed lines in FIGS. 1-2 and in solid lines in FIG. 3, impulse solenoid 300 may include a biasing mechanism 340. Biasing mechanism 340, when present, may be configured to bias, or urge, impulse solenoid 300 toward unactuated state 302. Additionally or alternatively, biasing mechanism 340 may be configured to transition the impulse solenoid from the actuated state to the unactuated state, such as may be subsequent to receipt of electrical impulse signal 362 by the impulse solenoid, subsequent to application of the electrical impulse signal for the impulse duration, and/or subsequent, or responsive, to a cease in supply of the electrical impulse signal to the impulse solenoid. Additionally or alternatively, biasing mechanism 340 may be configured to urge solenoid armature 320 toward unactuated position 322. Examples of biasing mechanism 340 include a resilient member, a spring, and/or a coil spring.

In some examples, and as illustrated in dashed lines in FIGS. 1-2 and in solid lines in FIG. 3, impulse solenoid 300 may include a brake assembly bias mechanism mount 350. Brake assembly bias mechanism mount 350, when present, may be adapted, configured, sized, shaped, and/or constructed to operatively attach to a brake assembly-biasing mechanism 144. As discussed in more detail herein, brake assembly-biasing mechanism 144 may be configured to urge brake assembly 120 toward impulse solenoid 300 and/or in a direction that is opposed to motive force 168. Stated differently, and when impulse solenoid 300 does not apply motive force 168, brake assembly-biasing mechanism 144 may urge the brake assembly toward a corresponding disengaged configuration 140 in which the brake assembly does not engage implement 40, as illustrated in FIG. 1.

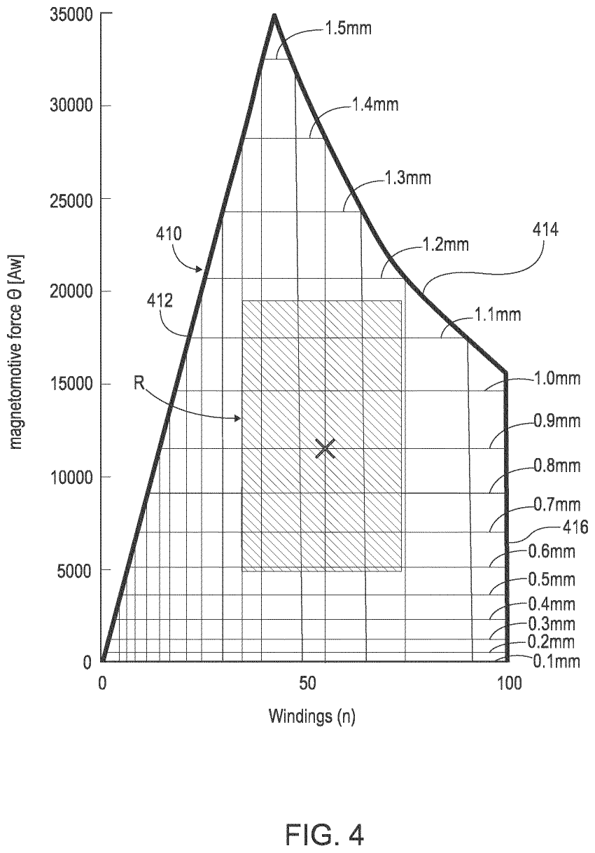

Impulse solenoid 300 may have and/or define any suitable construction that transitions between unactuated state 302 and actuated state 304 upon receipt of electrical impulse signal 362 and/or within the threshold transition time. However, certain constructions for impulse solenoid 300 may be advantageous and/or may provide improved performance when compared to other constructions. With this in mind, FIG. 4 is a plot illustrating magnetomotive force that may be generated by an impulse solenoid according to the present disclosure. More specifically, FIG. 4 is an example of a parametric analysis that illustrates the magnetomotive force produced by impulse coil 310 of the impulse solenoid, as indicated on the abscissa, for various numbers of windings of wound wire 312, as indicated on the ordinate. FIG. 4 further illustrates the impact of the diameter of the wound wire, as indicated by the horizontal lines in FIG. 4, on the magnetomotive force. More specifically, FIG. 4 illustrates magnetomotive force for wound wire diameters between 0.1 mm and 1.5 mm.

In the example of FIG. 4, the impulse voltage is assumed to be 42.4 Volts. In addition, it also is assumed that a peak impulse current is 820 amps, that a maximum time constant for the impulse coil is 0.39 ms, that a maximum wire diameter for the wound wire is 1.5 millimeters (mm), and that a maximum inductance for the impulse coil is 0.407 millihenry. As discussed in more detail herein, parametric analyses, such as those illustrated in FIG. 4, may be utilized to determine and/or establish one or more characteristics of impulse solenoids 300.

In FIG. 4, the dark operational boundary, which is indicated at 410, separates various regions of the parametric analysis. More specifically, wound wires 312 within regions to the left of the portion of operational boundary 410 that is indicated at 412 may cause unacceptably high peak currents within the wound wire upon receipt of the electrical impulse signal and/or may require that an impulse current of the electrical impulse signal be unacceptably high in order for the impulse solenoid to generate a desired magnetomotive force.

Wound wires 312 within regions to the right of the portion of operational boundary 410 that is indicated at 414 may have an unacceptably high time constant, which may produce an unacceptably high, or long, transition time for the impulse solenoid. Stated another way, wound wires within regions to the right of the line at 414 may be unable to transition the impulse solenoid from the unactuated state to the actuated state within the threshold transition time.

Wound wires 312 within regions to the right of the portion of operational boundary 410 that is indicated at 416 may have an undesirably large number of windings. This may increase an overall mass of the impulse solenoid and/or may make it difficult to apply the desired magnetomotive force with the impulse solenoid while also maintaining the impulse voltage within a desired range, examples of which are disclosed herein.

From the example parametric analysis of FIG. 4, a desired wire diameter and/or a desired number of windings for the wound wire may be selected. In general, it may be desirable to operate near, but not necessarily at, a maximum magnetomotive force that may be generated under a given set of constraints. With this in mind, and for the example parametric analysis of FIG. 4, impulse solenoids that include impulse coils with wire diameters of approximately 0.6 mm to 1.15 mm and with approximately 35-75 windings of the wound wire (e.g., within the region indicated at R) may be beneficial under the conditions that are illustrated in FIG. 4. In a specific example, 57 windings of wound wire with a diameter of 0.9 mm (as indicated by the X in FIG. 4) may be within operational boundary 410 and may provide a desired magnetomotive force of approximately 12,000 A t while, at the same time, avoiding potential instability that might be observed if a number of windings and wire diameter, which are closer to the peak in magnetomotive force, were to be utilized. More generally, and depending upon the exact configuration and constraints utilized, impulse solenoid 300 may be selected to exhibit one or more of the subsequently discussed characteristics.

In certain examples, impulse coil 310 and/or wound wire 312 thereof may have at least 10 wraps of wire, at least 20 wraps of wire, at least 30 wraps of wire, at least 40 wraps of wire, at least 45 wraps of wire, at least 50 wraps of wire, at least 55 wraps of wire, at least 60 wraps of wire, at least 65 wraps of wire, at least 70 wraps of wire, at least 75 wraps of wire, or at least 80 wraps of wire. Additionally or alternatively, the wound wire may have at most 120 wraps of wire, at most 110 wraps of wire, at most 100 wraps of wire, at most 90 wraps of wire, at most 80 wraps of wire, at most 75 wraps of wire, at most 70 wraps of wire, at most 65 wraps of wire, at most 60 wraps of wire, at most 55 wraps of wire, at most 50 wraps of wire, at most 45 wraps of wire, at most 40 wraps of wire, or at most 30 wraps of wire. The above-described ranges may be utilized because, in some examples, impulse coils 310 with fewer wraps of wire may be incapable of providing the desired magnetomotive force, while impulse coils with more wraps of wire may be undesirably large and/or heavy.

In certain examples, impulse coil 310 and/or wound wire 312 thereof may have a wire diameter of at least 0.3 mm, at least 0.4 mm, at least 0.5 mm, at least 0.6 mm, at least 0.7 mm, at least 0.8 mm, at least 0.9 mm, at least 1.0 mm, at least 1.1 mm, or at least 1.2 mm. Additionally or alternatively, the wound wire may have a wire diameter of at most 1.5 mm, at most 1.4 mm, at most 1.3 mm, at most 1.2 mm, at most 1.1 mm, at most 1.0 mm, at most 0.9 mm, at most 0.8 mm, at most 0.7 mm, or at most 0.6 mm. The above-described ranges may be utilized because, in some examples, impulse coils 310 with smaller wire diameters may have unacceptably large resistance values, while impulse coils with larger wire diameters may be undesirably large and/or heavy.

In certain examples, impulse coil 310 and/or wound wire 312 thereof may have a time constant, which may be defined as an inductance of the impulse coil divided by a resistance of the impulse coil, of at least 0.01 ms, at least 0.05 ms, at least 0.1 ms, at least 0.15 ms, or at least 0.2 ms. Additional examples of the time constant include time constants of at most 0.4 ms, at most 0.39 ms, at most 0.38 ms, at most 0.37 ms, at most 0.36 ms, at most 0.35 ms, at most 0.34 ms, at most 0.33 ms, at most 0.32 ms, at most 0.31 ms, at most 0.30 ms, at most 0.28 ms, at most 0.26 ms, at most 0.24 ms, at most 0.22 ms, at most 0.20 ms, at most 0.18 ms, at most 0.16 ms, at most 0.14 ms, at most 0.12 ms, or at most 0.10 ms. A specific example of the time constant is 0.39 ms. Time constants within these ranges may permit the impulse coil to transition from unactuated state 302 to actuated state 304 within the threshold transition times disclosed herein.

In certain examples, the impulse coil may have a coil inductance of at least 0.01 millihenry (mH), at least 0.05 mH, at least 0.1 mH, at least 0.15 mH, or at least 0.2 mH. Additionally or alternatively, the impulse coil may have a coil inductance of at most 0.44 mH, at most 0.42 mH, at most 0.40 mH, at most 0.38 mH, at most 0.36 mH, at most 0.34 mH, at most 0.32 mH, at most 0.30 mH, at most 0.28 mH, at most 0.26 mH, at most 0.24 mH, at most 0.22 mH, at most 0.20 mH, at most 0.18 mH, at most 0.16 mH, or at most 0.14 mH. In a specific example, the impulse coil may have a coil inductance of 0.41 mH. Inductances within these ranges may permit the impulse coil to transition from unactuated state 302 to actuated state 304 within the threshold transition times disclosed herein and/or may permit the impulse coil to generate magnetomotive forces within the ranges disclosed herein.

Returning to FIGS. 1-3, actuator assembly 160 may include a solenoid drive electric conduit 390. Solenoid drive electric conduit 390, when present, may be configured to convey electrical impulse signal 362 from solenoid drive circuitry 360 and/or to impulse solenoid 300. Examples of the solenoid drive electric conduit include a metallic conductor, a metallic wire, a metallic trace, an insulated metallic wire, a metallic cable, and an insulated metallic cable.

Solenoid drive electric conduit 390 may be selected and/or sized to repeatedly convey an impulse current of electrical impulse signal 362 for at least the impulse duration and/or at a duty cycle of the solenoid drive circuitry. This may include conveying the electrical impulse signal without damage to the solenoid drive electric conduit and/or with less than a threshold temperature increase of the solenoid drive electric conduit, which also may be referred to herein as a measurable, or a measured, threshold temperature increase. Examples of the electrical impulse signal and the impulse duration are disclosed herein. Examples of the duty cycle include duty cycles of at least 1*10\hat{ }-11, at least 1*10\hat{ }-10, at least 1*10\hat{ }-9, at least 1*10\hat{ }-8, at least 1*10\hat{ }-7, at least 1*10\hat{ }-6, at least 1*10\hat{ }-5, at least 1*10 \hat{ }-4, at most 1*10 \hat{ }-3, and/or at most 1*10 \hat{ }-4. The duty cycle may be defined as the impulse duration divided by the time between instances of supply of the electrical impulse signal to the impulse coil.

Examples of the threshold temperature increase of the solenoid drive electric conduit include temperature increases of less than 10° C., less than 20° C., less than 30° C., less than 40° C., less than 50° C., less than 60° C., less than 70° C., less than 80° C., less than 90° C., or less than 100° C. As discussed, this threshold temperature increase may be referred to herein as and/or may be a measurable temperature increase. As used herein, the phrase “measurable temperature increase” may refer to a temperature increase that persists for at least a threshold time period and/or that exists within at least a threshold volume of material, such as within a threshold volume of impulse coil 310 and/or of wound wire 312. Examples of the threshold time period include threshold time periods of at least 0.1 seconds, at least 0.25 seconds, at least 0.5 seconds, at least 1 second, at least 2.5 seconds, or at least 5 seconds. Examples of the threshold volume of material include volumes of at least 0.1 cubic millimeter, at least 0.25 cubic millimeters, at least 0.5 cubic millimeters, at least 1 cubic millimeter, at least 2.5 cubic millimeters, at least 5 cubic millimeters, or at least 10 cubic millimeters.

Solenoid drive circuitry 360 may include any suitable structure and/or structures that may be adapted, configured, designed, and/or constructed to selectively generate and/or provide the electrical impulse signal. This may include generating and/or providing the electrical impulse signal at the impulse voltage and/or for the impulse duration.

In some examples, the solenoid drive circuitry may be configured to generate and/or provide the electrical impulse signal with an impulse current. Examples of the impulse current include currents of at least 50 amps (A), at least 75 A, at least 100 A, at least 125 A, at least 150 A, at least 175 A, at least 200 A, at least 250 A, at least 300 A, at least 350 A, at least 400 A, at least 450 A, at least 500 A, at least 550 A, at least 600 A, at least 650 A, at least 700 A, at least 750 A, or at least 800 A. Additional and/or alternative examples of the impulse current include currents of at most 1000 A, at most 950 A, at most 900 A, at most 850 A, at most 800 A, at most 750 A, at most 700 A, at most 650 A, at most 600 A, at most 550 A, at most 500 A, at most 450 A, at most 400 A, at most 350 A, at most 300 A, or at most 250 A. These impulse currents may be sufficient to transition the impulse solenoid from unactuated position 322 to actuated position 324 within the threshold transition time, may be sufficient to generate the above-discussed magnetomotive force magnitudes, and/or may be insufficient to overheat the impulse solenoid, at least when provided at the above-discussed duty cycles.

In some examples, the solenoid drive circuitry may be configured to generate and/or provide the electrical impulse signal with a current rise rate. Examples of the current rise rate include rise rates of at least 20,000 amps/second (A/s), at least 25,000 A/s, at least 30,000 A/s, at least 35,000 A/s, at least 40,000 A/s, at least 45,000 A/s, at least 50,000 A/s, at least 55,000 A/s, at least 60,000 A/s, at least 70,000 A/s, at least 80,000 A/s, at least 90,000 A/s, at least 100,000 A/s, at least 200,000 A/s, at least 300,000 A/s, at least 400,000 A/s, at least 500,000 A/s, at least 600,000 A/s, at least 700,000 A/s, or at least 800,000 A/s. Additional and/or alternative examples of the current rise rate include rise rates of at most 1,000,000 A/s, at most 900,000 A/s, at most 800,000 A/s, at most 700,000 A/s, at most 600,000 A/s, at most 500,000 A/s, at most 400,000 A/s, at most 300,000 A/s, at most 200,000 A/s, or at most 100,000 A/s. These current rise rates may be sufficient to transition the impulse solenoid from unactuated position 322 to actuated position 324 within the threshold transition time.

In some examples, the solenoid drive circuitry may be configured to generate and/or provide the electrical impulse signal at a duty cycle. Examples of the duty cycle are disclosed herein. In some examples, and with reference to FIGS. 1-2 and 5, solenoid drive circuitry 360 may include a buffer circuit 370. Buffer circuit 370, when present, may be configured to selectively provide electrical impulse signal 362 to impulse solenoid 300. In some examples, solenoid drive circuitry 360 additionally or alternatively may include a converter 380. Converter 380, when present, may be configured to receive a power supply voltage 87, such as from a power cord 80 and/or a battery 85 of power tool 8, as illustrated in FIGS. 1-2, and to modify, to increase, or to decrease, the power supply voltage to the impulse voltage. In some examples, converter 380 may include and/or be a step-up converter, which may be configured to receive the power supply voltage from the electric power tool and to increase the power supply voltage to the impulse voltage. In some examples, converter 380 may include and/or be a step-down converter, which may be configured to receive the power supply voltage from the electric power tool and to decrease the power supply voltage to the impulse voltage.

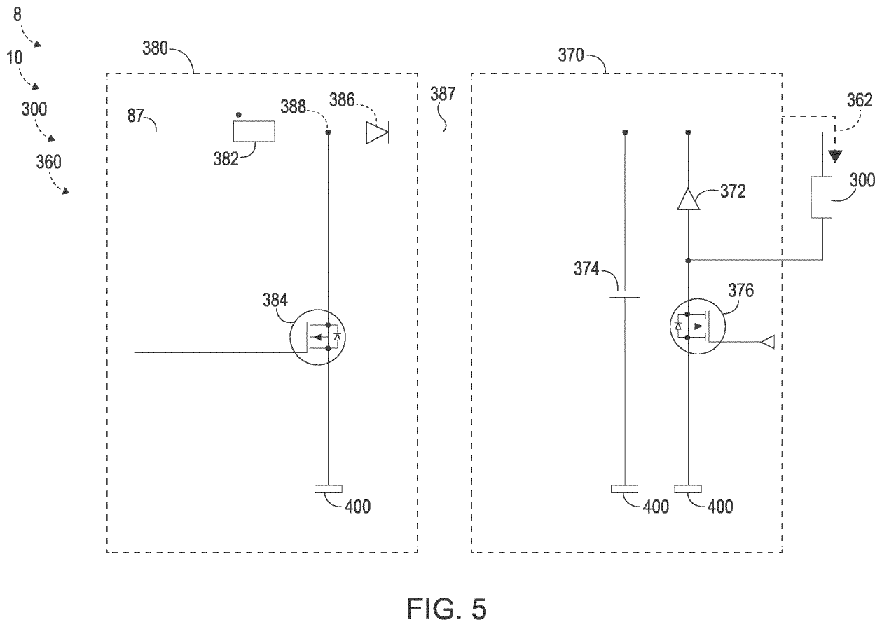

In a specific example, and as illustrated in FIG. 5, converter 380, in the form of a step-up converter, includes an inductor 382, a transistor 384, and a diode 386. Inductor 382 may be configured to receive power supply voltage 87 and to supply the power supply voltage to both transistor 384 and diode 386. Transistor 384 may be configured to selectively ground 400 the output from inductor 382 to generate voltage spikes at a node 388. The voltage spikes may have a magnitude that is greater than power supply voltage 87. Diode 386 may be configured to rectify the voltage spike and to provide a rectified current 387 to buffer circuit 370.

Buffer circuit 370 may include at least one diode 372, at least one capacitor 374, and at least one transistor 376. In the specific example of FIG. 5, capacitor 374 may receive and be charged by rectified current 387, such as to the impulse voltage. Impulse solenoid 300 also may receive the rectified current, and transistor 376 may selectively establish either a high impedance between the transistor and ground 400 or a low impedance between the transistor and ground 400. Stated another way, transistor 376 may selectively block the connection between the impulse solenoid and ground, may selectively disable the connection between the impulse solenoid and ground, and/or may selectively isolate the impulse solenoid from ground.

Transistor 376 may selectively ground an output of impulse solenoid 300, such as to initiate flow of electrical impulse signal 362 through the impulse solenoid. Diode 372 may interconnect the inputs and outputs of impulse solenoid 300, shunting the output of the impulse solenoid to the input of the impulse solenoid and decreasing a voltage drop across the impulse solenoid while transistor 376 provides a high impedance between the impulse solenoid and ground.

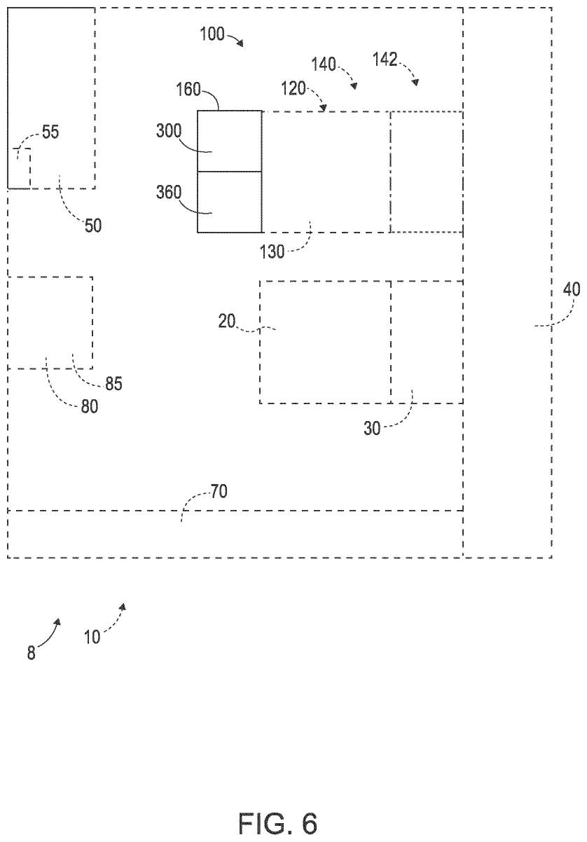

FIGS. 6-12 illustrate examples of power tools 8, or regions thereof, that include safety brakes 100 that utilize actuator assemblies 160, in the form of impulse solenoids 300, according to the present disclosure. Examples of power tools 8 include a saw, a rotary cutting tool, a fastening tool, a reciprocating tool, a vibratory tool, a woodworking tool, a metalworking tool, an automotive tool, a handheld power tool, and/or a portable power tool. Examples of the saw include a handheld circular saw, a miter saw, a radial arm saw, a table saw, a chop saw, a plunge saw, a track saw, a bevel saw, a bandsaw, a jigsaw, an up-cut saw, a chainsaw, and/or a panel saw. Examples of a rotary cutting tool include a router, a planer, a joiner, a sander, a drill, and/or a grinder. Examples of a fastening tool include a driver, a ratchet, and/or an impact driver. Examples of a reciprocating tool include a jigsaw and/or a reciprocating saw. Examples of the vibratory tool include a sander and/or a multi-tool.

In examples of power tools 8 that include handheld and/or portable power tools, it may be desirable to decrease and/or to minimize a size, a volume, and/or a weight of safety brakes 100. This may be due to overall size and/or weight constraints of such handheld and/or portable power tools. With this in mind, the small size and/or weight of impulse solenoids 300, which are utilized to actuate safety brakes 100, may permit and/or facilitate inclusion of safety brakes 100, according to the present disclosure, within power tools that otherwise could not utilize conventional safety brakes because of their significantly larger size and/or weight.

As discussed, power tools 8 may be configured to perform an operation on a workpiece. Examples of the operation include cutting, sawing, grinding, rotating, drilling, and/or fastening the workpiece. Examples of the workpiece include material to be cut, material to be removed, material to be drilled, a bolt, a screw, and/or a nut. Power tools 8 may utilize an implement 40 to perform the operation. Examples of implement 40 include any suitable bit, blade, socket, grinding wheel, chain, and/or sanding pad.

As collectively illustrated by FIGS. 6-12, power tools 8 may include a motor 20. Motor 20 may be configured to provide a motive force for actuation, or motion, of implement 40. In some examples, power tools 8 may include an implement holder 30, which may be configured to operatively attach implement 40 to the power tool and/or to convey the motive force from the motor to the implement. Examples of motor 20 include an electric motor, an AC electric motor, a DC electric motor, a brushless DC electric motor, a variable-speed motor, and/or a single-speed motor. Examples of implement holder 30 include a clamp, a fixture, a bar, a guide rail, and/or an arbor. Power tools 8 may include any suitable power source, and corresponding power structures, for powering motor 20 and/or safety brake 100. Examples of the power source include a power cord 80 and/or a battery 85, and it is within the scope of the present disclosure that the same or a different power source may be used for motor 20 and safety brake 100.

Power tools 8 also may include a gripping region 50. Gripping region 50, when present, may be configured to be gripped by the user of the power tool. An example of gripping region 50 includes a handle. Power tools 8 also may include a switch 55. Switch 55, when present, may be configured to be selectively actuated by the user of the power tool and/or to selectively apply an electric current to motor 20, such as to power motor 20. Examples of switch 55 include an electrical switch, a normally open electrical switch, a momentary electrical switch, and/or a locking momentary electrical switch.

Power tools 8 further may include a workpiece support 70. Workpiece support 70, when present, may be configured to support a workpiece and/or to position the power tool relative to the workpiece when the workpiece is operated on by the power tool.

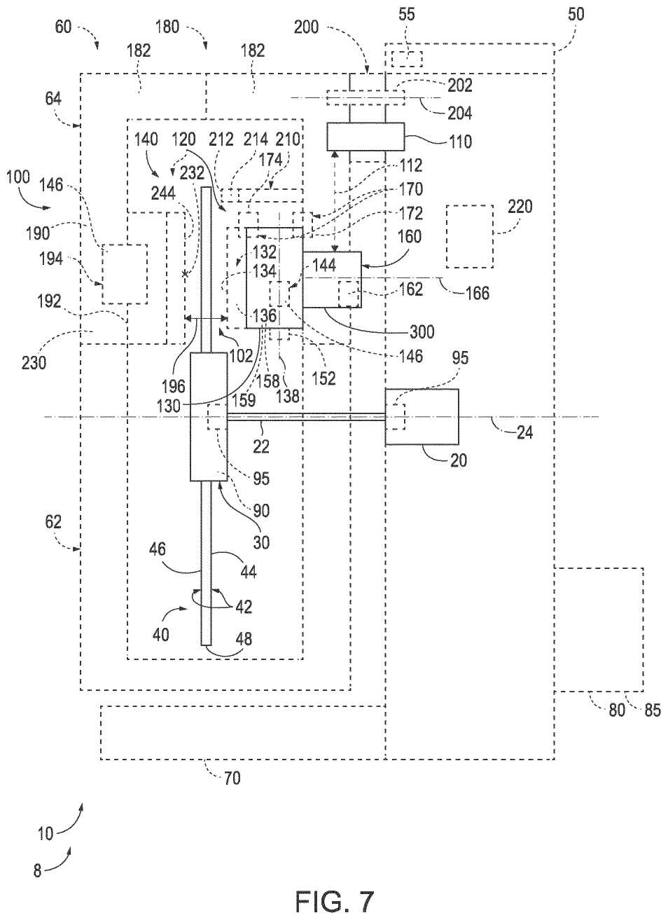

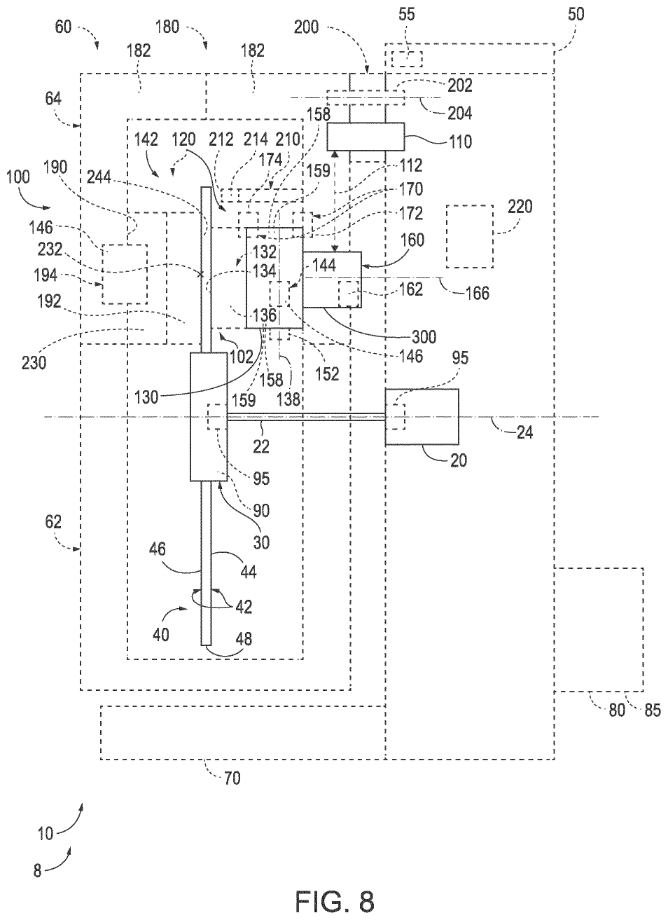

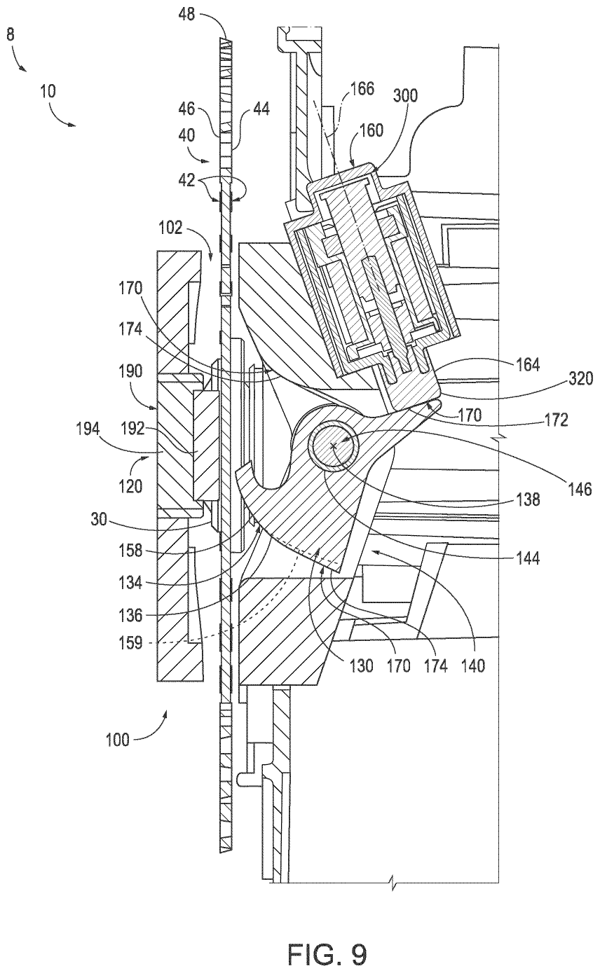

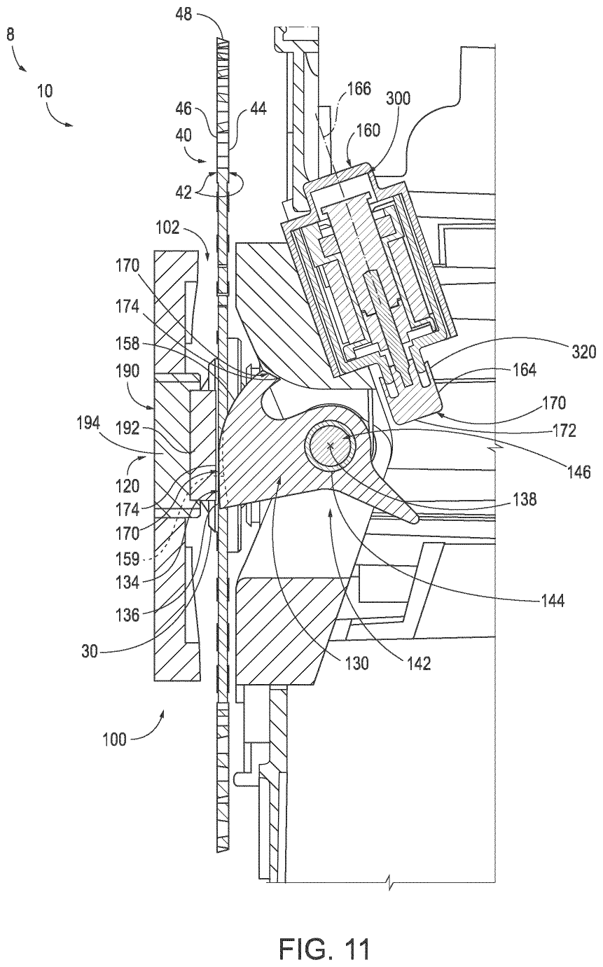

In addition to actuator assembly 160, safety brake 100 may include a brake assembly 120. As discussed in more detail herein, brake assembly 120 may be configured to transition, or to be transitioned, between a disengaged configuration 140, which is illustrated in dashed lines in FIG. 6 and in solid lines in FIGS. 7 and 9, and an engaged configuration 142, which is illustrated in dotted lines in FIG. 6 and in solid lines in FIGS. 8 and 11. The transition may be responsive to and/or a result of a transition of an impulse solenoid 300 of actuator assembly 160 from an unactuated state 302, as illustrated in FIGS. 1 and 3, to an actuated state, as illustrated in FIG. 2. When in disengaged configuration 140, brake assembly 120 is spaced apart from implement 40 and/or permits motion of the implement. When in engaged configuration 142, the brake assembly operatively engages implement 40 and/or resists motion of the implement. In some examples, and as discussed in more detail herein, brake assembly 120 may include a brake cam 130.

In some examples, power tools 8 may include and/or be circular saws 10, and FIGS. 7-12 illustrate examples of power tools 8 that include circular saws 10. Power tools 8, such as circular saws 10, include a motor 20, an implement holder 30, such as in the form of an arbor, and/or an implement 40, such as in the form of a circular saw blade. The motor includes a motor shaft 22 configured to rotate about a shaft rotational axis 24, as illustrated in FIGS. 7-8. The implement holder is operatively attached, either directly or indirectly, to the motor shaft. The implement is operatively attached to the power tool via the implement holder. Power tools 8, including circular saws 10, also include a safety brake 100 that defines an implement-receiving region 102, as illustrated in FIGS. 7-11, and implement 40 extends at least partially within the implement-receiving region. When implement 40 includes the circular saw blade, implement-receiving region 102 also may be referred to herein as a blade-receiving region.

The following discussions describe more specific examples of power tools 8 in the form of circular saws 10 that include safety brakes 100, according to the present disclosure. It is within the scope of the present disclosure that any of the structures, functions, and/or features, which are disclosed herein with reference to circular saws 10, may be included in and/or utilized with any suitable power tool 8, according to the present disclosure, as appropriate. With this in mind, references to circular saws 10 also may refer to electric power tools 8 and/or to power tools 8, references to circular saw blade 40 also may refer to implement 40, references to blade-receiving region 102 also may refer to implement-receiving region 102, and/or references to rotation of circular saw blade 40 also may refer to motion of implement 40.

During operation of circular saws 10, and as discussed in more detail herein, motor 20 may be utilized to provide a motive force for rotation of motor shaft 22 and attached circular saw blade 40 about shaft rotational axis 24. Circular saw blade 40 may include teeth 48, as illustrated in FIGS. 7-11, and rotation of the circular saw blade about the shaft rotational axis may permit and/or facilitate cutting of a workpiece with, via, and/or utilizing the circular saw.

In contrast with conventional circular saws that do not include safety brake 100, circular saws 10 according to the present disclosure may include additional safety features that may protect a user from harm, such as may be a result of contact between the user and the circular saw blade during rotation of the circular saw blade. More specifically, and as discussed in more detail herein, circular saws 10 are configured to detect situations in which there is a potential for injury and to immediately stop rotation of the circular saw blade responsive to such detection, thereby limiting and/or avoiding the injury. The rotation of the circular saw blade may be stopped by transitioning a brake assembly 120 of safety brake 100 from a disengaged configuration 140, as illustrated in FIGS. 7 and 9, to an engaged configuration 142, as illustrated in FIGS. 8 and 11. This transition from the disengaged configuration to the engaged configuration also is discussed in more detail herein.

As also illustrated in dashed lines in FIGS. 7-8, circular saws 10 may include a blade guard 60. Blade guard 60, when present, may be configured to cover, to house, and/or to contain at least a region of circular saw blade 40, such as to prevent, or to decrease a potential for, contact between the user and the circular saw blade. Blade guard 60 may include a retractable region 62 that may be configured to fold, rotate, and/or otherwise retract when the circular saw is utilized to cut the workpiece. In some examples of circular saws 10, at least a region 64 of blade guard 60 may be defined by, and/or may contain, safety brake 100. Stated another way, safety brake 100 may function as at least region 64 of blade guard 60 by preventing contact between the user of the circular saw and a region of circular saw blade 40 that extends within blade-receiving region 102.

Turning to FIGS. 7-8, circular saws 10 may include a clutch 90, which also may be referred to herein as a safety clutch 90. Clutch 90, when present, may be configured to decrease a potential for damage to at least one component of the circular saw, such as motor 20, motor shaft 22, arbor 30, a gear train of the circular saw, and/or safety brake 100 when safety brake 100 transitions from its disengaged configuration 140 to its engaged configuration 142, such as to stop rotation of circular saw blade 40. This decrease in potential for damage may be accomplished by at least partially mechanically uncoupling, or decoupling, circular saw blade 40 from motor shaft 22, thereby permitting rotation of motor shaft 22 independent from rotation of circular saw blade 40 and decreasing a rotational mass, or momentum, that must be stopped by safety brake 100 and/or permitting motor shaft 22 to cease rotation more slowly than circular saw blade 40. Clutch 90 may be incorporated into, may be defined within, and/or may be at least partially defined by arbor 30, by the gear train of the circular saw, and/or by a belt drive assembly of the circular saw.

Clutch 90 may operate in any suitable manner. As an example, clutch 90 may be configured to selectively permit rotation, or relative rotation, between the circular saw blade and the motor shaft when a torque between the circular saw blade and the motor shaft exceeds a threshold torque. As another example, clutch 90 may be configured to resist rotation, or relative rotation, between the circular saw blade and the motor shaft when the torque between the circular saw blade and the motor shaft is less than the threshold torque. Examples of clutch 90 include a torque-limiting clutch and a friction clutch.

As also illustrated in FIGS. 7-8 and discussed in more detail herein, electric power tools 8, circular saws 10, and/or safety brakes 100 thereof may include a sensor assembly 110, which may be configured to detect an actuation parameter. The actuation parameter may indicate that the actuator assembly should be utilized to actuate and/or to engage the safety brake. An example of the actuation parameter includes an undesired event parameter indicative of, or of the potential for, an undesired event to be avoided with and/or by the electric power tool and/or the circular saw. Another example of the actuation parameter includes a kickback parameter indicative of, or of a potential for, kickback of the electric power tool and/or the circular saw. Another example of the actuation parameter includes a movement parameter indicative of, or of a potential for, an undesired movement of the electric power tool and/or the circular saw. Yet another example of the actuation parameter includes a proximity parameter indicative of a distance between an individual, such as a user of the electric power tool, and the implement being less than a threshold distance. In various examples, and as discussed in more detail herein, the proximity parameter may be indicative of contact between the individual and the implement and/or the circular saw blade, of imminent contact between the individual and the implement and/or the circular saw blade, and/or of the distance between the individual and the implement and/or the circular saw blade being less than a small finite distance, examples of which are disclosed herein.

With continued reference to FIGS. 7-8, and in order to increase a sensitivity of, a signal-to-noise ratio of, and/or a potential for a false reading of the sensor assembly, circular saws 10 may include a blade isolation structure 95. Blade isolation structure 95, when present, may be configured to electrically isolate circular saw blade 40 from at least one other component of the circular saw. Examples of the at least one other component of the circular saw include gripping region 50, switch 55, an exterior surface of the circular saw, and/or regions of the circular saw that may be touched by the user when the circular saw is utilized to cut the workpiece. Additionally or alternatively, blade isolation structure 95 may be configured to electrically isolate circular saw blade 40 from ground, or from an earth ground.

Safety brakes 100 thus far have been described as being included in and/or as being a component of circular saws 10. It is within the scope of the present disclosure that safety brakes 100 may be incorporated into circular saws 10 in any suitable manner. As an example, circular saws 10 may be provided, from a manufacturer thereof, with safety brakes 100 already incorporated and/or included therein. As another example, safety brakes 100 may be configured to be included in, attached to, and/or retrofit to existing circular saws that did not necessarily include safety brakes 100 when originally produced and/or sold by the manufacturer. With this in mind, the following discussions of safety brakes 100 may refer to safety brakes 100 that are incorporated into circular saws 10 and/or of safety brakes 100 that may be produced and/or marketed as replacement safety brakes 100 for circular saws 10, and/or as safety brakes 100 that may be produced and/or marketed for retrofit installation on existing circular saws that did not include the safety brakes.

As illustrated by FIGS. 7-11, safety brakes 100 are configured to function as a safety brake for circular saw blades 40 of circular saws 10. As illustrated in FIGS. 7-8, safety brakes 100 include sensor assembly 110, a brake assembly 120, and an actuator assembly 160. As discussed, sensor assembly 110 is configured to detect an actuation parameter, examples of which are disclosed herein. The actuation parameter indicates that the actuator assembly should be utilized to actuate and/or to engage the safety brake, such as to stop rotation of the circular saw blade. Stated another way, sensor assembly 110 may be configured to detect an unsafe condition, such as a potential for contact between the individual and the circular saw blade and/or actual contact between the individual and the circular saw blade. Sensor assembly 110 then may be configured to generate a trigger signal 112, which is illustrated in FIGS. 7-8, responsive to detection of the actuation parameter.

In some examples, sensor assembly 110 may be configured to generate the trigger signal responsive to, or immediately responsive to, contact, or the initiation of contact, between the individual and the circular saw blade. In some such examples, the sensor assembly may be referred to herein as generating the trigger signal responsive to the distance between the individual and the circular saw blade being negligible and/or zero. In some examples, sensor assembly 110 may be configured to generate the trigger signal responsive to the distance between the individual and the circular saw blade being a small, finite distance. Examples of such small, finite distances include distances of less than 5 millimeters (mm), less than 4 mm, less than 3 mm, less than 2 mm, less than 1 mm, or less than 0.5 mm. In some such examples, the small, finite distance is greater than zero.

As discussed, brake assembly 120 includes a brake cam 130. Brake assembly 120 and/or brake cam 130 thereof may be configured to transition between disengaged configuration 140, as illustrated in FIGS. 7 and 9, and engaged configuration 142, as illustrated in FIGS. 8 and 11. When in disengaged configuration 140, the brake cam is spaced apart from blade-receiving region 102 of safety brake 100 and/or does not contact blade 40 of circular saw 10, as illustrated in FIGS. 7 and 9. In contrast, when in engaged configuration 142, the brake cam extends into blade-receiving region 102 and is configured to operatively engage with a planar side surface 42 of circular saw blade 40, such as to resist and/or stop rotation of the circular saw blade, as illustrated in FIGS. 8 and 11. Planar side surface 42 also may be referred to herein as a planar side surface of the implement.

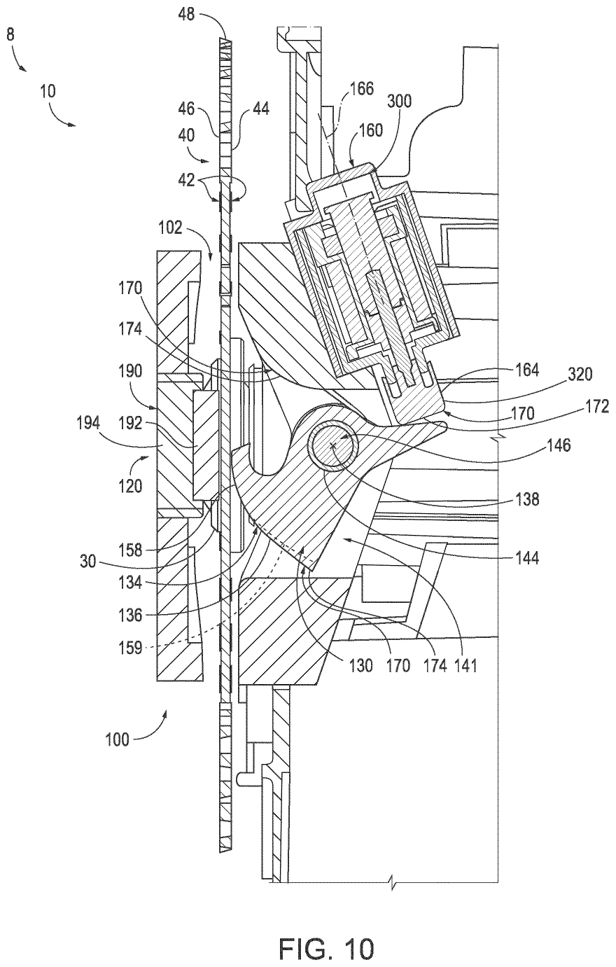

Actuator assembly 160 is configured to selectively transition brake assembly 120 and/or brake cam 130 thereof from the disengaged configuration to the engaged configuration. This selective transition may be performed responsive to, and/or as a result of, receipt of the trigger signal from the sensor assembly and/or by the actuator assembly. This selective transition is schematically illustrated in FIGS. 7-8 by the transition from the configuration of FIG. 7 to the configuration of FIG. 8 and/or in FIGS. 9-11 by the transition from the configuration of FIG. 9 to the configuration of FIG. 10, and subsequently to the configuration of FIG. 11.

Brake assembly 120 may include any suitable structure that includes brake cam 130 and that may be adapted, configured, designed, and/or constructed to selectively stop rotation of the circular saw blade and/or to selectively transition between disengaged configuration 140 and engaged configuration 142. In some examples, brake assembly 120 may include and/or be a non-destructive brake assembly 120, which may be configured to selectively stop rotation of the circular saw blade without damage to the circular saw blade and/or the brake assembly. In some examples, brake assembly 120 additionally or alternatively may include and/or be a resettable brake assembly, which may be configured to be selectively and repeatedly transitioned between the disengaged configuration and the engaged configuration, as discussed in more detail herein. In some examples, brake assembly 120 may include only one, or a single, brake cam 130; however, it also is within the scope of the present disclosure that brake assembly 120 may include more than one brake cam 130, such as a plurality of brake cams 130.

As discussed, brake assembly 120 and/or brake cam 130 thereof may be configured to selectively engage planar side surface 42 of circular saw blade 40. With this in mind, brake assembly 120 and/or brake cam 130 may be referred to herein as being free from engagement with teeth 48 of the circular saw blade and/or as being spaced apart from the teeth of the circular saw blade. This may include being free from engagement with the teeth and/or being spaced apart from the teeth both when the brake cam is in disengaged configuration 140 and when the brake cam is in engaged configuration 142.

As illustrated by the transition from the configuration of FIG. 7 to the configuration of FIG. 8 and/or by the transition from the configuration of FIG. 9 to the configuration of FIG. 11, brake cam 130 may be configured to rotate about a cam axis of rotation 138 to selectively transition, or as the brake cam selectively transitions, from disengaged configuration 140 to engaged configuration 142 and/or between the disengaged configuration and the engaged configuration. In some examples, blade-receiving region 102 may include and/or be a planar, or an at least substantially planar, blade-receiving region 102. In such examples, cam axis of rotation 138 may be parallel, or at least substantially parallel, to the planar blade-receiving region. Stated another way, cam axis of rotation 138 may be parallel, or at least substantially parallel, to planar side surface 42 of circular saw blade 40. In some examples, cam axis of rotation 138 may be perpendicular, or at least substantially perpendicular, to an actuation axis 166 of actuator assembly 160, as illustrated in FIGS. 7-11.

As illustrated in dashed lines in FIGS. 7-8 and in solid lines in FIGS. 9-12, safety brakes 100 and/or brake cams 130 thereof may include a brake assembly-biasing mechanism 144, which also may be referred to herein as a cam-biasing mechanism 144. Cam-biasing mechanism 144 may be configured to bias brake cam 130 toward and/or into disengaged configuration 140. Stated another way, cam-biasing mechanism 144 may cause brake cam 130 to remain in disengaged configuration 140 unless the brake cam is urged from the disengaged configuration and/or toward engaged configuration 142, such as by actuator assembly 160. Examples of cam-biasing mechanism 144 include a resilient cam-biasing mechanism, a cam-biasing spring, and/or a cam-biasing torsion spring.

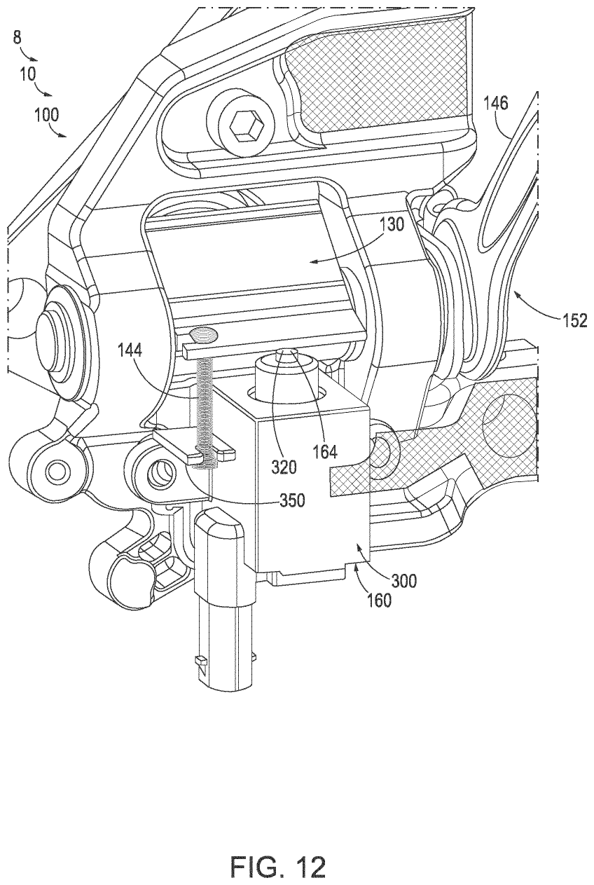

Cam biasing mechanism 144 may be defined in any suitable manner. As an example, and as illustrated in FIGS. 9-11, cam biasing mechanism 144 may bias brake cam 130 via a bias force applied between brake cam 130 and a structure that defines cam axis of rotation 138. As another example, and as illustrated in FIG. 12, cam biasing mechanism 144 may be operatively attached to actuator assembly 160, such as via a brake assembly bias mechanism mount 350, and may apply the bias force between the brake cam and the actuator assembly.

Brake cam 130 may have and/or define a blade-engaging surface 134, as illustrated in FIGS. 7-11, which also may be referred to herein as an implement-engaging surface 134. Blade-engaging surface 134 may be configured to operatively engage planar side surface 42 of the implement and/or of the circular saw blade, such as when the brake cam is in engaged configuration 142. In some examples, blade-engaging surface 134 may be shaped such that the brake cam presses progressively harder against a planar side surface of the circular saw blade as the brake cam rotates about cam axis of rotation 138 and/or as the brake cam transitions from disengaged configuration 140 to engaged configuration 142. In some such examples, brake cam 130 may include a region of increasing radius 158 and a region of constant radius 159, examples of which are schematically illustrated in FIGS. 7-11.

In some such examples, the brake cam may be configured initially to engage the circular saw blade with the region of increasing radius, as illustrated by an intermediate configuration 141 that is perhaps best illustrated in FIG. 10, and subsequently to engage the circular saw blade with the region of constant radius. Within the region of increasing radius, a distance between cam axis of rotation 138 and blade-engaging surface 134 may increase within a plane that is perpendicular to the cam axis of rotation, thereby causing the brake cam to press against the circular saw blade with a progressively harder force as the brake cam rotates in contact with the circular saw blade. Within the region of constant radius, and as also discussed, the distance between cam axis of rotation 138 and blade-engaging surface 134 may be constant within a plane that is perpendicular to the cam axis of rotation, thereby causing the brake cam to press with a constant, or at least substantially constant, force as the brake cam rotates further in contact with the saw blade.

In some examples, blade-engaging surface 134 may be shaped such that the brake cam automatically stops circular saw blade 40 and/or automatically transitions to the engaged configuration responsive to contact between the brake cam and the planar side surface of the circular saw blade. As an example, and as illustrated in FIG. 10, contact between blade-engaging surface 134 of brake cam 130 and circular saw blade 40 may urge the brake cam toward engaged configuration 142 of FIG. 11, such as may be due to the rotation of the circular saw blade and frictional forces between the brake cam and the circular saw blade.

In some examples, blade-engaging surface 134 may have and/or define an eccentric profile, or shape, relative to cam axis of rotation 138. As a more specific example, blade-engaging surface 134 may have and/or define a logarithmic spiral profile, or shape. The specific shape and/or profile of blade-engaging surface 134 may be designed and/or selected based upon a coefficient of friction between planar side surface 42 and brake cam 130, such as to provide a desired stopping force to blade 40 when the brake cam transitions to the engaged configuration. As another example, the friction between the brake cam and the planar side surface, once initiated, may urge the brake cam toward and/or to the engaged configuration.

Stated another way, safety brake 100, brake cam 130, and/or blade-engaging surface 134 may be configured such that frictional force between the circular saw blade and the brake cam, during rotation of the circular saw blade, urges the brake cam toward and/or into engaged configuration 142. Thus, and once actuator assembly 160 urges brake cam 130 into contact with circular saw blade 40, the frictional force may cause the brake cam to exert a greater and greater stopping force on the circular saw blade until rotation of the circular saw blade ceases. This configuration may be referred to herein as a self-reinforcing safety brake.

In some examples, brake cam 130 may include a cam friction material 136, which may define blade-engaging surface 134 and/or which may be selected to increase the coefficient of friction between the blade-engaging surface and the circular saw blade. Examples of cam friction material 136 include a diamond coating, an abrasive material, an abrasive grit coating, a ceramic material, a sintered material, and/or a metal alloy.

In some examples, blade-engaging surface 134 may be integral to and/or defined by brake cam 130. In other examples, the blade-engaging surface may be applied to the brake cam and/or may coat the brake cam. In other examples, brake cam 130 may include a blade-engaging surface insert 132, as illustrated in FIGS. 7-8. Blade-engaging surface insert 132 also may be referred to herein as an implement-engaging surface insert. Blade-engaging surface insert 132, when present, may be operatively attached to a remainder of the brake cam, may form and/or define blade-engaging surface 134, and/or may include and/or may be defined by cam friction material 136. In some such examples, brake cam 130 and/or blade-engaging surface insert 132 may be configured to be repaired and/or replaced, such as subsequent to greater than a threshold amount of wear and/or subsequent to transitioning the brake cam from the disengaged configuration to the engaged configuration greater than a threshold number of times. Additionally or alternatively, brake cam 130 may be configured to be repaired and/or replaced.

Safety brake 100, brake assembly 120, and/or brake cam 130 may be configured such that upon being transitioned from disengaged configuration 140 to engaged configuration 142, the brake cam remains in the engaged configuration. Such safety brakes 100, brake assemblies 120, and/or brake cams 130 may be referred to herein as and/or may be self-locking safety brakes 100, self-locking brake assemblies 120, and/or self-locking brake cams 130, respectively.

As an example, safety brakes 100, brake assemblies 120, and/or brake cams 130 may be configured to remain in the engaged configuration until the brake cam is released from the engaged configuration, such as by the user of the circular saw. Stated another way, and as discussed in more detail herein, actuation of a reset mechanism 146 by the user of the circular saw may be required for brake assembly 120 to transition from the engaged configuration to the disengaged configuration. This further may increase safety of circular saws 10 that include safety brakes 100, such as by forcing the user to acknowledge and/or correct condition(s) that caused the brake assembly to transition to the engaged configuration prior to subsequent operation of the circular saw.

Safety brake 100, brake assembly 120, and/or brake cam 130 may utilize any suitable mechanism to remain in and/or within the engaged configuration. As an example, brake cam 130 may be shaped to remain in the engaged configuration. As a more specific example, brake cam 130 may include a lock region and/or a flattened region that retains the brake cam in the engaged configuration. As another example, operative engagement and/or a force between the circular saw blade and the brake cam may retain the brake cam in the engaged configuration.

Brake assembly 120 may include a stop 170, as illustrated in FIGS. 7-11. Stop 170, when present, may be configured to limit rotation of brake cam 130, such as about cam axis of rotation 138. In some examples, stop 170 may include a disengaged configuration stop 172, which may be configured to limit rotation of the brake cam away from blade-receiving region 102 while the brake cam is in the disengaged configuration. In some examples, stop 170 may include an engaged configuration stop 174, which may be configured to limit rotation of the brake cam toward and/or into blade-receiving region 102 while the brake cam is in the engaged configuration.

It is within the scope of the present disclosure that stop 170 may be defined in any suitable manner. As an example, stop 170, in the form of engaged configuration stop 174, may be at least partially defined by brake cam 130, such as by a shape and/or profile of the brake cam, such as a flat region of the brake cam, that limits rotation thereof. As another example, stop 170 may be configured to operatively engage with the brake cam to limit rotation of the brake cam, such as when an actuator arm 164 of actuator assembly 160 engages the brake assembly and/or the brake cam, as illustrated in FIGS. 9-11. As yet another example, stop 170, in the form of engaged configuration stop 174, may include and/or be a structure and/or surface of brake assembly 120 that engages with the brake cam when the brake cam reaches engaged configuration 142. As another example, stop 170, in the form of disengaged configuration stop 172, may be at least partially defined by actuator arm 164.

As illustrated in FIGS. 7-8, brake assembly 120 may include a housing 180, which also may be referred to herein as a caliper 180. Housing 180 may be configured to operatively support brake cam 130 and/or actuator assembly 160. Additionally or alternatively, housing 180 may at least partially surround blade-receiving region 102. Housing 180 may be formed from a mechanically stiff material, such as a metal or plastic. Such a configuration may decrease deflection when brake cam 130 transitions to the engaged configuration and/or may decrease a time needed for the brake cam to stop rotation of the circular saw blade upon transitioning from the disengaged configuration to the engaged configuration.

Housing 180 may include a split housing that is configured to be disassembled into two or more separate and/or distinct housing regions 182. In such a configuration, and as discussed in more detail herein, separation of housing regions 182 may permit brake assembly 120 to be reset and/or to transition from the engaged configuration to the disengaged configuration.

As illustrated in FIGS. 7-11, safety brake 100 and/or brake assembly 120 thereof may, in addition to brake cam 130, include a brake pad 190. Brake pad 190, when present, may include a pad friction material 192, examples of which are disclosed herein with reference to cam friction material 136. Brake pad 190 may be positioned, within brake assembly 120 and/or relative to brake cam 130, such that pad friction material 192 faces toward brake cam 130, faces toward blade-receiving region 102, and/or faces toward circular saw blade 40. Additionally or alternatively, brake pad 190 may be positioned such that blade-receiving region 102 extends at least partially between the brake pad and the brake cam. Brake assembly 120 may be configured such that, when the brake assembly is in the engaged configuration, at least a region of implement 40, such as of the circular saw blade, is compressed between brake pad 190 and brake cam 130.

In some examples, brake pad 190 may include a pivotal pad mount 230, as illustrated in FIGS. 7-8. Pivotal pad mount 230, when present, may be configured to permit limited rotation of brake pad 190, such as about a pivot point 232. Additionally or alternatively, pivotal pad mount 230 may be configured to permit limited rotation of brake pad 190 about at least one pivot axis or even about a plurality of pivot axes. Such a configuration may permit a friction surface 244 of brake pad 190 to align with, or rest flat against, the circular saw blade despite misalignment between brake assembly 120 and/or the circular saw blade and/or despite deflection of the brake assembly and/or the circular saw blade. This may permit and/or facilitate even load and/or force distribution between circular saw blade 40 and brake pad 190 and/or friction surface 244 thereof.

This even load and/or force distribution between the brake pad and the saw blade also may permit and/or facilitate even load and/or force distribution between the brake cam and the circular saw blade. Such even load and/or force distributions may decrease a magnitude of point forces on various components of the circular saw, which may permit lighter components to be utilized, may decrease wear of the components, and/or may increase a service life of the components. Friction surface 244 may include and/or be a planar, or an at least substantially planar, friction surface 244, which may be configured for at least partial, or even complete, face-to-face contact with the planar side surface of the circular saw blade.

As illustrated in dashed lines in FIGS. 7-8, brake assembly 120 may include an adjustment mechanism 194. Adjustment mechanism 194, when present, may be configured to selectively adjust, or to be utilized to selectively adjust, a distance 196, which is illustrated in FIG. 7, between the brake pad and the brake cam. Such adjustment may permit and/or facilitate utilization of circular saw blades 40 having different thicknesses within circular saw 10 and/or may permit safety brake 100 to define a desired spacing between brake pad 190 and the circular saw blade, regardless of differences in thickness and/or other properties of the circular saw blade. As an example, adjustment mechanism 194 may include detents for predefined and/or specific circular saw blade thicknesses. An example of adjustment mechanism 194 includes a threaded fastener configured to adjust the distance between the brake pad and the brake cam.

Circular saw blade 40 may include a plurality of planar side surfaces 42, including a first planar side surface 44 and a second planar side surface 46, which may be opposed to the first planar side surface. Stated differently, implement 40 may include both first planar side surface 44 and second planar side surface 46. In such a configuration, brake cam 130 may be configured to operatively engage first planar side surface 44, and brake pad 190 and/or pad friction material 192 thereof, when present, may be configured to operatively engage the second planar side surface 46 of the circular saw blade.

Safety brake 100 may include an attachment mechanism 200, as illustrated in FIGS. 7-8, which may be configured to operatively attach at least a portion of the safety brake, such as brake cam 130, actuator assembly 160, housing 180, and/or brake pad 190, to circular saw 10. In some examples, attachment mechanism 200 may maintain a fixed, or at least substantially fixed, relative orientation between blade-receiving region 102 and a remainder of the circular saw. In some examples, attachment mechanism 200 may include and/or be a floating attachment mechanism configured to permit blade-receiving region 102 to operatively translate relative to the remainder of the circular saw, such as along a float axis 204 that may be perpendicular, or at least substantially perpendicular, to planar side surface 42 of the circular saw blade. Such a configuration may permit brake pad 190 to remain fixed, or at least substantially fixed, relative to housing 180 during actuation of brake assembly 120 from the disengaged configuration to the engaged configuration while permitting both brake pad 190 and brake cam 130 to engage circular saw blade 40 when in the engaged configuration. An example of floating attachment mechanism 200 includes an attachment pin 202, or a plurality of attachment pins 202. In such a configuration, the attachment mechanism may be configured to permit blade-receiving region 102 to operatively translate relative to a remainder of the circular saw along a longitudinal axis of the attachment pin, such as float axis 204.

Actuator assembly 160 may include a power source 162, as illustrated in FIGS. 7-8. Power source 162, which may form a portion of and/or may be defined by solenoid drive circuitry 360 of FIGS. 1-2 and 5-6, may be configured to power the actuator assembly. In some examples, power source 162 may be configured to power the actuator assembly even if a primary power supply of the circular saw is unavailable to power motor 20. Examples of power source 162 include an electric power source, such as a mains power supply, an AC power source, a DC power source, a battery, and/or a capacitor.

As discussed, actuator assembly 160 may include actuator arm 164, as illustrated in FIGS. 1-3 and 9-12. Actuator arm 164 may be configured to selectively extend from the actuator assembly and/or to selectively transition the brake assembly and/or the brake cam from the disengaged configuration to the engaged configuration. As also discussed, actuator arm 164 may include and/or be a solenoid armature 320 of impulse solenoid 300. Actuator arm 164, in the form of the solenoid armature, may be in direct physical contact with brake assembly 120 and/or with brake cam 130 as the brake assembly transitions from the disengaged configuration to the engaged configuration. Stated another way, brake assembly 120 may be free from an intervening mechanical and/or pivotal linkage that interconnects the actuator arm and the brake cam. Such a construction may decrease an overall mass of moving parts within the brake assembly and/or may increase a speed at which the brake assembly transitions from the disengaged configuration to the engaged configuration.

Turning to FIGS. 7-8, sensor assembly 110 may include any suitable structure that may be adapted, configured, designed, and/or constructed to detect the actuation parameter and/or to generate the trigger signal. An example of sensor assembly 110 includes a capacitive sensor assembly configured to detect the actuation parameter. Additional examples of sensor assembly 110 and/or of other components that may be incorporated into and/or utilized with circular saws 10 and/or safety brakes 100, according to the present disclosure, are disclosed in U.S. Pat. Nos. 7,536,238, 7,971,613, and 9,724,840, and also in International Patent Application Publication No. WO 2017/210091, the complete disclosures of which are hereby incorporated by reference.

With continued reference to FIGS. 7-8, safety brake 100 may include a deflection-mitigating structure 210, which may at least partially define blade-receiving region 102. Deflection-mitigating structure 210, when present, may be configured to resist deflection of implement 40, such as the saw blade, into contact with brake assembly 120 and/or brake cam 130 thereof when the implement is utilized to cut a workpiece and the brake assembly is in the disengaged configuration. Stated another way, and in some examples, the workpiece may cause the circular saw blade to deflect toward the brake cam. As discussed herein, brake cam 130 may be configured such that, upon contact with the rotating circular saw blade, the brake cam automatically transitions to the engaged configuration, such as via frictional forces between the circular saw blade and the brake cam. Such a transition during normal cutting operations of the circular saw, or without detection of the actuation parameter, may be undesirable. As such, deflection-mitigating structure 210 may be utilized to decrease a potential for this undesirable contact between the circular saw blade and the brake cam.

Deflection-mitigating structure 210 may resist contact between the circular saw blade and the brake cam in any suitable manner. As an example, deflection-mitigating structure 210 may include a deflection-mitigating surface 212, which may be configured to operatively contact implement 40 when the implement is deflected toward the brake cam. In a specific example, deflection-mitigating surface 212 may be positioned to be contacted by circular saw blade 40 prior to the circular saw blade being deflected into contact with the brake cam. As a result, deflection-mitigating surface 212 may prevent the circular saw blade from being deflected into contact with the brake cam.

As discussed in more detail herein with reference to blade isolation structure 95, it may be desirable to electrically insulate circular saw blade 40 from one or more other components of circular saw 10. With this in mind, at least deflection-mitigating surface 212 of deflection-mitigating structure 210 may be electrically isolated from a remainder of the circular saw blade.

In some examples, deflection-mitigating structure 210 may include an electrically isolating structure 214, which also may be referred to herein as an electrically insulating spacer 214, that electrically isolates the circular saw blade from the one or more other components of the circular saw during contact between the deflection-mitigating structure and the circular saw blade. An example of the electrically isolating structure includes an electrical insulator.

In some examples, deflection-mitigating structure 210 may be defined by an electrically insulating material that defines deflection-mitigating surface 212. As a specific example, deflection-mitigating structure 210 may be at least partially, or even completely, defined by a ceramic material.

As discussed, subsequent to a transition to engaged configuration 142, safety brakes 100 may be configured to remain in the engaged configuration at least until the user of the circular saw transitions the circular saw to the disengaged configuration. With this in mind, safety brakes 100 may include a reset mechanism 146, as illustrated in FIGS. 7-12, which may be configured to permit the user of the circular saw to selectively transition the brake cam from the engaged configuration to the disengaged configuration, such as to permit continued utilization of the circular saw to cut the workpiece.

An example of reset mechanism 146 includes an eccentric structure, such as an eccentric shaft, eccentric bushings, and/or eccentric bearings. The eccentric structure may have an off-center lobe and/or may be configured to be rotated to move, or to operatively translate, brake cam 130 away from implement-receiving region 102, away from the blade-receiving region, away from implement 40, and/or away from circular saw blade 40. Subsequent to being moved away from the implement, brake cam 130 may automatically be urged to rotate to the disengaged configuration.

Another example of reset mechanism 146 includes adjustment mechanism 194, as illustrated in FIGS. 7-11, which may be utilized to move the brake pad away from the circular saw blade, thereby permitting the brake cam to return to the disengaged configuration. In such an example, a tool, such as a hex wrench, may be utilized to loosen the adjustment mechanism, thereby moving brake pad 190 away from the circular saw blade and permitting the brake cam to return to the disengaged configuration.

Yet another example of reset mechanism 146 includes housing 180 with distinct housing regions 182, as illustrated in FIGS. 7-8, that may be separated, such as via a fastener, thereby permitting the brake cam to return to the disengaged configuration. Another example of reset mechanism 146 includes a pressure-actuated reset mechanism. The pressure-based reset mechanism may be configured to release and/or to decrease a pressure applied to brake pad 190 and/or to brake cam 130 to permit the brake cam and/or the brake pad to translate away from blade-receiving region 102 and/or out of contact with the circular saw blade, thereby permitting the brake cam to return to the disengaged configuration via action of cam-biasing mechanism 144. As an example, the pressure-actuated reset mechanism may include a hydraulic cylinder that is depressurized to move brake pad 190 and/or brake cam 130 away from and/or out of contact with the circular saw blade, thereby permitting the brake cam to return to the disengaged configuration.

Yet another example of reset mechanism 146 may include rotation of circular saw blade 40 in a direction that is opposed to the direction in which the circular saw blade rotates when powered by motor 20. This may be accomplished by pressing the circular saw blade against the workpiece. Additionally or alternatively, a tool, such as a hex wrench, may be utilized to rotate arbor 30 in the direction that is opposed to the direction in which the circular saw blade rotates when powered by motor 20. In either instance, this rotation may cause brake cam 130 to rotate toward the disengaged configuration, thereby decreasing a force applied to the circular saw blade by the brake cam. After at least a threshold degree of angular rotation, the brake cam may return to the disengaged configuration, such as via action of cam-biasing mechanism 144.

Another example of reset mechanism 146 includes a cam rotation structure 152, as illustrated in FIGS. 7-8 and 12. Cam rotation structure 152 may be attached to, selectively attached to, and/or associated with brake cam 130 and/or may be configured to selectively rotate the brake cam away from the circular saw blade. For example, cam rotation structure 152 may be configured to be selectively actuated by the user to rotate the brake cam away from the circular saw blade, such as by engaging the cam rotation structure with a tool, such as a wrench. In some examples, the cam rotation structure may be temporarily and/or selectively engaged with the brake cam. In other examples, the cam rotation tool may be permanently, or at least substantially permanently, attached to the safety brake and/or may be configured to be selectively engaged, or interlocked, with the brake cam. The cam rotation tool may be utilized to rotate the brake cam away from the circular saw blade. In some examples, the cam rotation structure may include and/or be a pretensioned lever, such as which may be tensioned by a lever spring.

As discussed, safety brake 100 may be utilized to protect the user of circular saw 10 from injury, such as may be caused by contact between the user and a rotating circular saw blade 40. To facilitate this protection, brake assembly 120 may be configured to transition brake cam 130 from the disengaged configuration to the engaged configuration within a threshold transition time. Examples of the threshold transition time include threshold transition times of at least 0.1 milliseconds (ms), at least 0.5 ms, at least 1 ms, at least 2 ms, at least 3 ms, at least 4 ms, at least 5 ms, at most 10 ms, at most 9 ms, at most 8 ms, at most 7 ms, at most 6 ms, at most 5 ms, at most 4 ms, at most 3 ms, and/or at most 2 ms.

The speed at which brake cam 130 transitions from the disengaged configuration to the engaged configuration may be measured and/or quantified in any suitable manner. As an example, a high-speed camera with a frame speed of, for example, 50,000 frames per second, has been utilized to observe the circular saw blade and/or the brake cam during rotation of the circular saw blade. A light, such as a light emitting diode, also was visible to the camera and was configured to illuminate responsive to the trigger signal being received by the actuator assembly. In such a configuration, counting a number of frames from illumination of the light until rotation of the circular saw blade ceases was utilized to quantify the time needed for brake assemblies 120 to stop rotation of the circular saw blade. The observed time was, in various configurations, within the above-described ranges.

In some examples, and as illustrated in dashed lines in FIGS. 7-8, electric power tools 8, circular saws 10 and/or safety brakes 100 may include an interlock assembly 220. Interlock assembly 220, when present, may be configured to permit, or to selectively permit, supply of electric current to motor 20 when safety brake 100 is configured to selectively resist motion of the implement and/or rotation of the circular saw blade. Additionally or alternatively, interlock assembly 220 may be configured to block, or to selectively block, supply of electric current to the motor when at least one component of the safety brake is not configured, or unable, to selectively resist motion of the implement and/or rotation of the circular saw blade. Stated another way, interlock assembly 220 may be configured to permit the motor to move the implement, or to rotate the circular saw blade, when the configuration of safety brake 100 is such that the safety brake will protect the individual from contact with the moving implement, or the rotating circular saw blade, and interlock assembly 220 may be configured not to permit, or to resist, the motion of the implement, or rotation of the circular saw blade, when the configuration of safety brake 100 is such that the safety brake cannot protect the individual from contact with the moving implement, or the rotating circular saw blade.

As an example, interlock assembly 220 may include a sensor status detector configured to indicate a status of sensor assembly 110. In some such examples, interlock assembly 220 may not permit the motor to drive the rotation of the circular saw blade if the sensor status detector indicates that the sensor assembly is not configured to detect the actuation parameter, such as may be caused by a failure of the sensor assembly and/or electrical interference with the sensor assembly. Additionally or alternatively, the interlock assembly may permit the motor to drive the rotation of the circular saw blade if the sensor status detector indicates that the sensor assembly is configured to detect the actuation parameter.

As another example, interlock assembly 220 may include a brake assembly status detector configured to indicate a status of brake assembly 120. In some such examples, interlock assembly 220 may not permit the motor to drive the rotation of the circular saw blade if the brake assembly status detector indicates that the brake assembly is not configured to selectively resist rotation of the circular saw blade, such as may be caused by a failure of the brake assembly, a maladjustment of the brake assembly, and/or a failure of an operator to properly reset the brake assembly. Additionally or alternatively, the interlock assembly may permit the motor to drive the rotation of the circular saw blade if the brake assembly status detector indicates that the brake assembly is configured to selectively resist rotation of the circular saw blade.

As yet another example, interlock assembly 220 may include an actuator assembly status detector configured to indicate a status of actuator assembly 160. In some such examples, interlock assembly 220 may not permit the motor to drive the rotation of the circular saw blade if the actuator assembly status detector indicates that the actuator assembly is not configured to selectively urge the brake cam into contact with the circular saw blade, such as may be caused by a failure of the actuator assembly and/or debris build-up proximate the actuator assembly and/or the brake cam. Additionally or alternatively, the interlock assembly may permit the motor to drive the rotation of the circular saw blade if the actuator assembly status detector indicates that the actuator assembly is configured to selectively urge the brake cam into contact with the circular saw blade.

Interlock assembly 220 additionally or alternatively may include any suitable structure that may be adapted, configured, designed, and/or programmed to permit, or to selectively permit, supply of electric current to motor 20 when safety brake 100 is configured to selectively resist rotation of the circular saw blade. As examples, interlock assembly 220 may include a transistor, a relay, a switch, an electric switch, and/or a controller. When the interlock assembly includes the controller, the controller may be programmed to control the operation of the interlock assembly and/or to perform the functions of the interlock assembly that are disclosed herein.

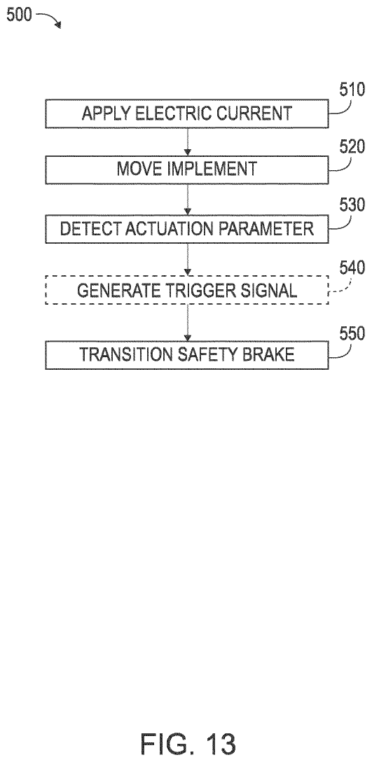

Electric power tools 8 that include safety brakes 100, such as circular saws 10 that include brake assemblies 120, according to the present disclosure, may be operated in a manner that protects an individual, such as a user of the electric power tool, from injury caused by contact with a moving implement. Such operation may be referred to herein as methods 500 of operating a circular saw and are illustrated in FIG. 13.

Methods 500 include applying an electric current at 510 and moving an implement at 520. Methods 500 also include detecting an actuation parameter at 530, and methods 500 may include generating a trigger signal at 540. Methods 500 further include transitioning a safety brake at 550.

The applying at 510 may include applying the electric current to a motor of the electric power tool, such as to operate, to actuate, to initiate motion of, to move, to initiate rotation of, and/or to rotate, the motor. In some examples of methods 500, and as discussed in more detail herein, the electric power tool may include and/or be a battery powered electric power tool. In such examples, the electric current may be provided by a battery of the battery powered electric power tool. Examples of the electric power tool are disclosed herein with reference to electric power tool 8. Examples of the motor are disclosed herein with reference to motor 20.

The moving at 520 may include moving the implement of the electric power tool. This may include rotating, translating, spinning, and/or reciprocating the implement. The moving at 520 may be responsive to, a result of, and/or subsequent to the applying at 510. As an example, the electric power tool may be configured such that motion of the motor causes the implement to move. Examples of the implement are disclosed herein with reference to implement 40.

The detecting at 530 may include detecting any suitable actuation parameter and may be performed during, at least partially concurrently with, subsequent to, and/or responsive to, the moving at 520. The actuation parameter may be indicative of an undesired event to be avoided with and/or by the electric power tool. Additionally or alternatively, the actuation parameter may indicate that the transitioning at 550 should be initiated, such as to avoid injury to a user of the electric power tool and/or damage to a workpiece that is operated upon by the electric power tool. Examples of the actuation parameter are disclosed herein. Examples of sensor assemblies, which may be utilized to detect the actuation parameter, are disclosed herein with reference to sensor assemblies 110.

The generating at 540 may include generating the trigger signal responsive to the detecting at 530. In such examples, the trigger signal may be provided to an actuator assembly, and the transitioning at 550 may be responsive to and/or a result the generating at 540 and/or receipt of the trigger signal by the actuator assembly. Examples of the actuator assembly are disclosed herein with reference to actuator assembly 160.

The transitioning at 550 may include transitioning the safety brake of the electric power tool from a disengaged configuration to an engaged configuration. The transitioning at 550 may be performed subsequent to, responsive to, and/or as a result of the detecting at 530. When in the disengaged configuration, the safety brake permits, or does not resist, motion of the implement. When in the engaged configuration, the safety brake resists and/or stops motion of the implement. The safety brake includes the actuator assembly that includes solenoid drive circuitry and an impulse solenoid. The solenoid drive circuitry is configured to generate an electrical impulse signal responsive to detection of the actuation parameter, and the transitioning at 550 includes providing the electrical impulse signal to the impulse solenoid to transition the impulse solenoid from an unactuated state to an actuated state, thereby transitioning the brake assembly from the disengaged configuration to the engaged configuration.

Examples of the safety brake are disclosed herein with reference to safety brake 100. Examples of the disengaged configuration are disclosed herein with reference to disengaged configuration 140. Examples of the engaged configuration are disclosed herein with reference to engaged configuration 142. Examples of the solenoid drive circuitry are disclosed herein with reference to solenoid drive circuitry 360. Examples of the impulse solenoid are disclosed herein with reference to impulse solenoid 300.

In some examples, the transitioning at 550 may include generating a magnetomotive force with the impulse solenoid and/or utilizing the magnetomotive force as a motive force for the transitioning. In some examples, the transitioning at 550 may include moving a solenoid armature of the solenoid through an armature range of motion. In some examples, and during the transitioning at 550, the solenoid armature contacts, or directly contacts, a brake cam of the safety brake, examples of which are disclosed herein with reference to brake cam 130.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

As used herein, “at least substantially,” when modifying a degree or relationship, may include not only the recited “substantial” degree or relationship, but also the full extent of the recited degree or relationship. A substantial amount of a recited degree or relationship may include at least 75% of the recited degree or relationship. For example, an object that is at least substantially formed from a material includes objects for which at least 75% of the objects are formed from the material and also includes objects that are completely formed from the material. As another example, a first length that is at least substantially as long as a second length includes first lengths that are within 75% of the second length and also includes first lengths that are as long as the second length.

Illustrative, non-exclusive examples of actuator assemblies 160, electric power tools 8, and/or of safety brakes 100 according to the present disclosure are presented in the following enumerated paragraphs. It is within the scope of the present disclosure that an individual step of a method recited herein, including in the following enumerated paragraphs, may additionally or alternatively be referred to as a “step for” performing the recited action.
A1. An actuator assembly configured to selectively provide a motive force to transition a brake assembly for an implement of an electric power tool from a disengaged configuration to an engaged configuration, the actuator assembly comprising:
an impulse solenoid; and
solenoid drive circuitry;
wherein the impulse solenoid is configured to be selectively transitioned from an unactuated state to an actuated state responsive to receipt of an electrical impulse signal;
wherein the impulse solenoid is configured to provide the motive force while transitioning from the unactuated state to the actuated state;
wherein the solenoid drive circuitry is configured to selectively generate the electrical impulse signal; and
optionally wherein the electrical impulse signal has an impulse voltage of at most 43 volts and an impulse duration of at most 10 milliseconds and is configured to transition the impulse solenoid from the unactuated state to the actuated state in a transition time of at most 15 milliseconds.
A2. The actuator assembly of paragraph A1, wherein the actuator assembly is configured to apply the motive force to the brake assembly to initiate a chain reaction of the brake assembly.
A3. The actuator assembly of any of paragraphs A1-A2, wherein the impulse solenoid is configured to generate a magnetomotive force responsive to receipt of the electrical impulse signal and to generate the motive force from the magnetomotive force, wherein the magnetomotive force has a magnitude of at least one of:
(i) at least 5,000 Ampere-turn (A t), at least 6,000 A t, at least 7,000 A t, at least 7,500 A t, at least 10,000 A t, or at least 12,500 A t; and
(ii) at most 20,000 A t, at most 19,000 A t, at most 18,000 A t, at most 17,000 A t, at most 16,000 A t, at most 15,000 A t, at most 14,000 A t, at most 13,000 A t, at most 12,000 A t, at most 11,000 A t, or at most 10,000 A t.
A4. The actuator assembly of any of paragraphs A1-A3, wherein the impulse solenoid includes an impulse coil configured to receive the electrical impulse signal and to generate a magnetic field responsive to receipt of the electrical impulse signal.
A5. The actuator assembly of paragraph A4, wherein the impulse coil is at least partially defined by a wound wire.
A6. The actuator assembly of paragraph A5, wherein at least a region of the wound wire is a helically wound wire.
A7. The actuator assembly of any of paragraphs A5-A6, wherein the wound wire includes at least one of:
(i) at least 10 wraps of wire, at least 20 wraps of wire, at least 30 wraps of wire, at least 40 wraps of wire, at least 45 wraps of wire, at least 50 wraps of wire, at least 55 wraps of wire, at least 60 wraps of wire, at least 65 wraps of wire, at least 70 wraps of wire, at least 75 wraps of wire, or at least 80 wraps of wire; and
(ii) at most 120 wraps of wire, at most 110 wraps of wire, at most 100 wraps of wire, at most 90 wraps of wire, at most 80 wraps of wire, at most 75 wraps of wire, at most 70 wraps of wire, at most 65 wraps of wire, at most 60 wraps of wire, at most 55 wraps of wire, at most 50 wraps of wire, at most 45 wraps of wire, at most 40 wraps of wire, or at most 30 wraps of wire.
A8. The actuator assembly of any of paragraphs A5-A7, wherein the wire includes at least one of an electrically conductive wire, an aluminum wire, and a copper wire.
A9. The actuator assembly of any of paragraphs A5-A8, wherein the wire has a diameter of at least one of:
(i) at least 0.3 millimeters (mm), at least 0.4 mm, at least 0.5 mm, at least 0.6 mm, at least 0.7 mm, at least 0.8 mm, at least 0.9 mm, at least 1.0 mm, at least 1.1 mm, or at least 1.2 mm; and
(ii) at most 1.5 mm, at most 1.4 mm, at most 1.3 mm, at most 1.2 mm, at most 1.1 mm, at most 1.0 mm, at most 0.9 mm, at most 0.8 mm, at most 0.7 mm, or at most 0.6 mm.
A10. The actuator assembly of any of paragraphs A4-A9, wherein the impulse coil has a time constant of at least one of:
(i) at least 0.01 milliseconds (ms), at least 0.05 ms, at least 0.1 ms, at least 0.15 ms, or at least 0.2 ms; and
(ii) at most 0.4 ms, at most 0.39 ms, at most 0.38 ms, at most 0.37 ms, at most 0.36 ms, at most 0.35 ms, at most 0.34 ms, at most 0.33 ms, at most 0.32 ms, at most 0.31 ms, at most 0.30 ms, at most 0.28 ms, at most 0.26 ms, at most 0.24 ms, at most 0.22 ms, at most 0.20 ms, at most 0.18 ms, at most 0.16 ms, at most 0.14 ms, at most 0.12 ms, or at most 0.10 ms.
A11. The actuator assembly of any of paragraphs A4-A10, wherein the impulse coil has a coil inductance of at least one of:
(i) at least 0.01 millihenry (mH), at least 0.05 mH, at least 0.1 mH, at least 0.15 mH, or at least 0.2 mH; and
(ii) at most 0.44 mH, at most 0.42 mH, at most 0.40 mH, at most 0.38 mH, at most 0.36 mH, at most 0.34 mH, at most 0.32 mH, at most 0.30 mH, at most 0.28 mH, at most 0.26 mH, at most 0.24 mH, at most 0.22 mH, at most 0.20 mH, at most 0.18 mH, at most 0.16 mH, or at most 0.14 mH.
A12. The actuator assembly of any of paragraphs A1-A11, wherein the impulse solenoid includes a solenoid armature configured to operatively translate between an unactuated position and an actuated position as the impulse solenoid transitions between the unactuated state and the actuated state.
A13. The actuator assembly of paragraph A12, wherein the solenoid armature defines an elongate axis, and further wherein the solenoid armature is configured to linearly translate along the elongate axis as the impulse solenoid transitions between the unactuated state and the actuated state.
A14. The actuator assembly of any of paragraphs A12-A13, wherein the solenoid armature is configured to operatively engage the brake assembly to selectively apply the motive force to the brake assembly.
A15. The actuator assembly of any of paragraphs A12-A14, wherein the solenoid armature is configured to receive a/the magnetomotive force from a/the impulse coil and to selectively apply the motive force to the brake assembly responsive to receipt of the magnetomotive force.
A16. The actuator assembly of any of paragraphs A12-A15, wherein the solenoid armature has an armature mass of at least one of:
(i) at least 1 gram (g), at least 2 g, at least 3 g, at least 4 g, at least 5 g, at least 6 g, at least 7 g, at least 8 g, at least 9 g, at least 10 g, at least 12 g, at least 14 g, at least 16 g, at least 18 g, at least 20 g, or at least 25 g; and
(ii) at most 40 g, at most 38 g, at most 36 g, at most 34 g, at most 32 g, at most 30 g, at most 28 g, at most 26 g, at most 24 g, at most 22 g, at most 20 g, at most 18 g, at most 16 g, at most 14 g, at most 12 g, at most 10 g, or at most 8 g.
A17. The actuator assembly of any of paragraphs A12-A16, wherein the solenoid armature defines an armature range of motion between the unactuated position and the actuated position, and optionally wherein the armature range of motion is at least one of:
(i) at least 0.5 millimeters (mm), at least 1.0 mm, at least 1.5 mm, at least 2.0 mm, at least 2.5 mm, at least 3 mm, at least 3.5 mm, or at least 4.0 mm; and
(ii) at most 10 mm, at most 9.0 mm, at most 8.0 mm, at most 7.0 mm, at most 6.0 mm, at most 5.5 mm, at most 5.0 mm, at most 4.5 mm, at most 4.0 mm, at most 3.5 mm, at most 3.0 mm, at most 2.5 mm, or at most 2.0 mm.
A17.1. The actuator assembly of any of paragraphs A12-A17, wherein the solenoid armature includes a pin and an anchor that is operatively attached to the pin.
A17.2. The actuator assembly of paragraph A17.1, wherein an anchor diameter of the anchor is greater than a pin diameter of the pin.
A17.3. The actuator assembly of any of paragraphs A17.1-A17.2, wherein the pin defines a rounded pin end that is configured to engage with the brake assembly.
A17.4. The actuator assembly of any of paragraphs A17.1-A17.3, wherein the pin defines a/the pin diameter of at least one of:
(1) at least 2 mm, at least 2.5 mm, at least 3 mm, at least 3.5 mm, at least 4 mm, at least 4.5 mm, or at least 5 mm; and
(ii) at most 7 mm, at most 6.5 mm, at most 6 mm, at most 5.5 mm, at most 5 mm, at most 4.5 mm, at most 4 mm, at most 3.5 mm, or at most 3 mm.
A17.5. The actuator assembly of any of paragraphs A17.1-A17.4, wherein the anchor defines an/the anchor diameter of at least one of:
(i) at least 10 mm, at least 10.5 mm, at least 11 mm, at least 11.5 mm, at least 12 mm, at least 12.5 mm, at least 13 mm, at least 13.5 mm, or at least 14 mm; and
(ii) at most 17 mm, at most 16.5 mm, at most 16 mm, at most 15.5 mm, at most 15 mm, at most 14.5 mm, at most 14 mm, at most 13.5 mm, at most 13 mm, at most 12.5 mm, or at most 12 mm.
A17.6. The actuator assembly of any of paragraphs A12-A17.5, wherein the solenoid armature defines an armature length of at least one of:
(i) at least 25 mm, at least 30 mm, at least 35 mm, at least 40 mm, at least 45 mm, or at least 50 mm; and
(ii) at most 70 mm, at most 65 mm, at most 60 mm, at most 55 mm, at most 50 mm, at most 45 mm, or at most 40 mm.
A17.7. The actuator assembly of any of paragraphs A1-A17.6, wherein the impulse solenoid further includes a cap, optionally wherein at least one of:
(i) the cap is operatively attached to, and configured to move with, a/the solenoid armature; and
(ii) the cap includes a central bore through which the solenoid armature extends.
A18. The actuator assembly of any of paragraphs A1-A17.7, wherein the impulse solenoid further includes a biasing mechanism configured to at least one of:
(i) urge the impulse solenoid toward the unactuated state;
(ii) transition the impulse solenoid from the actuated state to the unactuated state, optionally subsequent to receipt of the electrical impulse signal by the impulse solenoid; and
(iii) urge a/the solenoid armature toward a/the unactuated position.
A19. The actuator assembly of paragraph A18, wherein the biasing mechanism includes at least one of:
(i) a resilient member;
(ii) a spring; and
(iii) a coil spring.
A20. The actuator assembly of any of paragraphs A1-A19, wherein the impulse voltage is at least one of:
(i) at least 10 volts (V), at least 15 V, at least 20 V, at least 25 V, at least 30 V, at least 35 V, or at least 40 V;
(ii) at most 42 V, at most 41 V, at most 40 V, at most 38 V, at most 36 V, at most 34 V, at most 32 V, or at most 30 V; and
(iii) at least substantially equal to, or equal to, 42.4 V.
A21. The actuator assembly of any of paragraphs A1-A20, wherein the impulse duration is at least one of:
(i) at least 0.25 milliseconds (ms), at least 0.5 ms, at least 0.75 ms, at least 1.0 ms, at least 1.5 ms, at least 2.0 ms, at least 2.5 ms, at least 3.0 ms, at least 3.5 ms, at least 4.0 ms, at least 4.5 ms, at least 5.0 ms, at least 5.5 ms, at least 6.0 ms, at least 6.5 ms, at least 7.0 ms, at least 7.5 ms, or at least 8.0 ms; and
(ii) at most 9 ms, at most 8.5 ms, at most 8.0 ms, at most 7.5 ms, at most 7.0 ms, at most 6.5 ms, at most 6.0 ms, at most 5.5 ms, at most 5.0 ms, at most 4.5 ms, at most 4.0 ms, at most 3.5 ms, at most 3.0 ms, at most 2.5 ms, or at most 2.0 ms.
A22. The actuator assembly of any of paragraphs A1-A21, wherein the solenoid drive circuitry is configured to generate the electrical impulse signal with an impulse current of at least one of:
(i) at least 50 amps (A), at least 75 A, at least 100 A, at least 125 A, at least 150 A, at least 175 A, at least 200 A, at least 250 A, at least 300 A, at least 350 A, at least 400 A, at least 450 A, at least 500 A, at least 550 A, at least 600 A, at least 650 A, at least 700 A, at least 750 A, or at least 800 A; and
(ii) at most 1000 A, at most 950 A, at most 900 A, at most 850 A, at most 800 A, at most 750 A, at most 700 A, at most 650 A, at most 600 A, at most 550 A, at most 500 A, at most 450 A, at most 400 a, at most 350 A, at most 300 A, or at most 250 A.
A23. The actuator assembly of any of paragraphs A1-A22, wherein the solenoid drive circuitry is configured to generate the electrical impulse signal with a current rise rate of at least one of:
(i) at least 20,000 amps/second (A/s), at least 25,000 A/s, at least 30,000 A/s, at least 35,000 A/s, at least 40,000 A/s, at least 45,000 A/s, at least 50,000 A/s, at least 55,000 A/s, at least 60,000 A/s, at least 70,000 A/s, at least 80,000 A/s, at least 90,000 A/s, at least 100,000 A/s, at least 200,000 A/s, at least 300,000 A/s, at least 400,000 A/s, at least 500,000 A/s, at least 600,000 A/s, at least 700,000 A/s, or at least 800,000 A/s; and
(ii) at most 1,000,000 A/s, at most 900,000 A/s, at most 800,000 A/s, at most 700,000 A/s, at most 600,000 A/s, at most 500,000 A/s, at most 400,000 A/s, at most 300,000 A/s, at most 200,000 A/s, or at most 100,000 A/s.
A24. The actuator assembly of any of paragraphs A1-A23, wherein the solenoid drive circuitry is configured to have a duty cycle of at least one of:
(i) at least 1*10\hat{ }-11, at least 1*10\hat{ }-10, at least 1*10\hat{ }-9, at least 1*10\hat{ }-8, at least 1*10\hat{ }-7, at least 1*10\hat{ }-6, at least 1*10\hat{ }-5, at least 1*10\hat{ }-4; and
(ii) at most 1*10\hat{ }-3 or at most 1*10\hat{ }-4.
A25. The actuator assembly of any of paragraphs A1-A24, wherein the solenoid drive circuitry includes a buffer circuit configured to selectively provide the electrical impulse signal.
A26. The actuator assembly of any of paragraphs A1-A25, wherein the solenoid drive circuitry includes at least one of:
(1) a step-up converter configured to receive a power supply voltage from the electric power tool and to increase the power supply voltage to the impulse voltage; and
(ii) a step-down converter configured to receive the power supply voltage from the electric power tool and to decrease the power supply voltage to the impulse voltage.
A27. The actuator assembly of any of paragraphs A1-A26, wherein the actuator assembly further includes a solenoid drive electric conduit configured to convey the electrical impulse signal from the solenoid drive circuitry to the impulse solenoid.
A28. The actuator assembly of paragraph A27, wherein the solenoid drive electric conduit is sized to repeatedly convey an/the impulse current of the electrical impulse signal for the impulse duration at least one of:
(i) without damage to the solenoid drive electric conduit; and
(ii) with less than a threshold temperature increase of the solenoid drive electric conduit, optionally wherein the threshold temperature increase is at least one of less than 10° C., less than 20° C., less than 30° C., less than 40° C., less than 50° C., less than 60° C., less than 70° C., less than 80° C., less than 90° C., or less than 100° C.
A29. The actuator assembly of any of paragraphs A27-A28, wherein the solenoid drive electric conduit is sized to repeatedly convey an/the impulse current of the electrical impulse signal at a/the duty cycle of the solenoid drive circuitry at least one of:
(i) without damage to the solenoid drive electric conduit; and
(ii) with less than a threshold temperature increase of the solenoid drive electric conduit, optionally wherein the threshold temperature increase is at least one of less than 10° C., less than 20° C., less than 30° C., less than 40° C., less than 50° C., less than 60° C., less than 70° C., less than 80° C., less than 90° C., or less than 100° C.
A30. The actuator assembly of any of paragraphs A27-A29, wherein the solenoid drive electric conduit includes at least one of a metallic conductor, a metallic wire, an insulated metallic wire, a metallic cable, and an insulated metallic cable.
A31. The actuator assembly of any of paragraphs A1-A30, wherein the actuator assembly further includes a brake assembly bias mechanism mount configured to operatively attach to a brake assembly-biasing mechanism of the brake assembly.
B1. A safety brake for an implement of an electric power tool, the safety brake comprising:
(i) a brake assembly configured to be transitioned between a disengaged configuration, in which the brake assembly permits motion of the implement, and an engaged configuration, in which the brake assembly resists motion of the implement; and
(ii) the actuator assembly of any of paragraphs A1-A31.
B2. The safety brake of paragraph B1, wherein the brake assembly includes a brake cam configured to selectively transition between the disengaged configuration and the engaged configuration, when in the disengaged configuration, the brake cam is spaced apart from an implement-receiving region of the safety brake that is configured to receive the implement, and wherein in the engaged configuration, the brake cam extends into the implement-receiving region and is configured to operatively engage the implement and resist motion of the implement; and
wherein the actuator assembly is configured to selectively transition the brake cam from the disengaged configuration to the engaged configuration as the impulse solenoid transitions from the unactuated state to the actuated state.
B3. The safety brake of paragraph B2, wherein the brake cam is configured to rotate about a cam axis of rotation to selectively transition between the disengaged configuration and the engaged configuration.
B4. The safety brake of paragraph B3, wherein the implement-receiving region is a planar, or an at least substantially planar, implement-receiving region, and further wherein the cam axis of rotation is parallel, or at least substantially parallel, to the planar implement-receiving region.
B5. The safety brake of any of paragraphs B2-B4, wherein the brake cam includes a cam-biasing mechanism that biases the brake cam toward the disengaged configuration.
B6. The safety brake of paragraph B5, wherein the cam-biasing mechanism includes at least one of:
(i) a resilient cam-biasing mechanism;
(ii) a cam-biasing spring; and
(iii) a cam-biasing torsion spring.
B7. The safety brake of any of paragraphs B2-B6, wherein the brake cam defines an implement-engaging surface configured to operatively engage a planar side surface of the implement.
B8. The safety brake of paragraph B7, wherein the implement-engaging surface is shaped such that the brake cam presses progressively harder against the implement as the brake cam transitions from the disengaged configuration to the engaged configuration.
B9. The safety brake of any of paragraphs B7-B8, wherein the implement-engaging surface defines an eccentric profile.
B10. The safety brake of any of paragraphs B7-B9, wherein the implement-engaging surface defines a logarithmic spiral profile.
B11. The safety brake of any of paragraphs B7-B10, wherein the implement-engaging surface includes a cam friction material selected to increase a coefficient of friction between the implement-engaging surface and the implement.
B12. The safety brake of paragraph B11, wherein the cam friction material includes at least one of:
(i) a diamond coating;
(ii) an abrasive material;
(iii) an abrasive grit coating;
(iv) a ceramic material;
(v) a sintered material; and
(vi) a metal alloy.
B13. The safety brake of any of paragraphs B7-B12, wherein the brake cam includes an implement-engaging surface insert that is operatively attached to a remainder of the brake cam and defines the implement-engaging surface.
B14. The safety brake of any of paragraphs B7-B13, wherein the implement-engaging surface is integral to the brake cam.
B15. The safety brake of any of paragraphs B7-B14, wherein the implement-engaging surface is at least one of applied to the brake cam and coats the brake cam.
B16. The safety brake of any of paragraphs B2-B15, wherein, subsequent to being transitioned from the disengaged configuration to the engaged configuration, the brake cam is shaped to remain in the engaged configuration, optionally until the brake cam is released from the engaged configuration by a user of the electric power tool.
B17. The safety brake of paragraph B16, wherein operative engagement between the implement, or the circular saw blade, and the brake cam retains the brake cam in the engaged configuration.
B18. The safety brake of any of paragraphs B2-B17, wherein the brake assembly includes a stop configured to limit rotation of the brake cam.
B19. The safety brake of paragraph B18, wherein the stop includes a disengaged configuration stop configured to limit rotation of the brake cam away from the implement-receiving region while the brake cam is in the disengaged configuration.
B20. The safety brake of any of paragraphs B18-B19, wherein the stop includes an engaged configuration stop configured to limit rotation of the brake cam toward the implement-receiving region while the brake cam is in the engaged configuration.
B21. The safety brake of any of paragraphs B18-B20, wherein at least one of:
(i) the stop is at least partially defined by the brake cam; and
(ii) the stop is distinct from the brake cam and is configured to operatively engage with the brake cam to limit rotation of the brake cam.
B22. The safety brake of any of paragraphs B2-B21, wherein the brake assembly further includes a housing configured to operatively support the brake cam and the actuator assembly.
B23. The safety brake of paragraph B22, wherein the housing at least partially surrounds the implement-receiving region of the safety brake.
B24. The safety brake of any of paragraphs B22-B23, wherein the housing includes a split housing configured to be disassembled into at least two housing regions.
B25. The safety brake of any of paragraphs B1-B24, wherein the brake assembly further includes a brake pad that includes a pad friction material.
B26. The safety brake of paragraph B25, wherein the brake pad is positioned, relative to a/the brake cam, such that the pad friction material faces toward the brake cam.
B27. The safety brake of any of paragraphs B25-B26, wherein the brake pad is positioned, relative to a/the brake cam, such that a/the implement-receiving region of the safety brake extends at least partially between the brake pad and the brake cam.
B28. The safety brake of any of paragraphs B25-B27, wherein the brake pad includes an adjustment mechanism configured to selectively adjust a distance between the brake pad and a/the brake cam.
B29. The safety brake of any of paragraphs B25-B28, wherein a/the planar side surface of the implement is a first planar side surface of the implement, wherein the implement includes a second planar side surface, which is opposed to the first planar side surface, and further wherein the pad friction material is configured to operatively engage the second planar side surface.
B30. The safety brake of any of paragraphs B25-B29, wherein the brake assembly is configured such that, when a/the brake cam is in the engaged configuration, the implement is compressed between the brake pad and the brake cam.
B31. The safety brake of any of paragraphs B2-B30, wherein the safety brake is free from a pivotal linkage between the brake cam and the actuator assembly.
B32. The safety brake of any of paragraphs B2-B31, wherein a/the cam axis of rotation of the brake cam is perpendicular, or at least substantially perpendicular, to an actuation axis of the actuator assembly.
B33. The safety brake of any of paragraphs B2-B32, wherein the brake assembly includes a single brake cam.
B34. The safety brake of any of paragraphs B2-B33, wherein the brake assembly is a locking brake assembly configured to remain in the engaged configuration once the brake cam operatively engages the implement.
B35. The safety brake of any of paragraphs B1-B34, wherein the safety brake further includes a sensor assembly configured to detect an actuation parameter and to generate a trigger signal responsive to detection of the actuation parameter.
B36. The safety brake of paragraph B35, wherein the sensor assembly includes a capacitive sensor assembly configured to detect the actuation parameter.
B37. The safety brake of any of paragraphs B35-B36, wherein the actuation parameter includes an undesired event parameter indicative of an undesired event to be avoided with the electric power tool.
B38. The safety brake of any of paragraphs B35-B37, wherein the actuation parameter includes a kickback parameter indicative of a potential for kickback of the electric power tool.
B39. The safety brake of any of paragraphs B35-B38, wherein the actuation parameter includes a movement parameter indicative of an undesired movement of the electric power tool.
B40. The safety brake of any of paragraphs B35-B39, wherein the actuation parameter includes a proximity parameter indicative of a distance between an individual and the implement being less than a threshold distance.
B41. The safety brake of paragraph B40, wherein the sensor assembly includes a proximity sensor configured to detect the proximity parameter.
B42. The safety brake of any of paragraphs B1-B41, wherein the brake assembly is a non-destructive brake assembly configured to selectively stop motion of the implement.
B43. The safety brake of any of paragraphs B1-B42, wherein the brake assembly is a resettable brake assembly configured to be selectively and repeatedly transitioned between the disengaged configuration and the engaged configuration.
B44. The safety brake of any of paragraphs B1-B43, wherein the brake assembly is configured to resist motion of the implement at least one of:
(i) without damage to the implement; and
(ii) without damage to the brake assembly.
B45. The safety brake of any of paragraphs B1-B44, wherein the safety brake further includes an attachment mechanism configured to operatively attach at least a portion of the safety brake to the electric power tool.
B46. The safety brake of paragraph B45, wherein the attachment mechanism includes a floating attachment mechanism configured to permit a/the implement-receiving region of the safety brake to operatively translate relative to a remainder of the electric power tool, optionally along a float axis that is at least substantially perpendicular to a/the planar side surface of a/the circular saw blade.
B47. The safety brake of paragraph B46, wherein the floating attachment mechanism includes an attachment pin, and further wherein the attachment mechanism is configured to permit the implement-receiving region to operatively translate relative to the remainder of the electric power tool and along a longitudinal axis of the attachment pin.
B48. The safety brake of any of paragraphs B1-B47, wherein the actuator assembly is an electrical actuator assembly.
B49. The safety brake of any of paragraphs B1-B48, wherein the actuator assembly includes a power source configured to power the actuator assembly, optionally wherein the power source includes a capacitor.
B50. The safety brake of any of paragraphs B1-B49, wherein the actuator assembly includes an actuator arm configured to selectively transition the brake assembly from the disengaged configuration to the engaged configuration.
B51. The safety brake of any of paragraphs B1-B50, wherein the actuator assembly includes an electromagnet configured to selectively transition the brake assembly from the disengaged configuration to the engaged configuration.
B52. The safety brake of any of paragraphs B1-B51, wherein the actuator assembly includes a/the solenoid armature, wherein the solenoid armature is configured to operatively engage the brake assembly, or a/the brake cam of the brake assembly, to transition the brake assembly, or the brake cam of the brake assembly, from the disengaged configuration to the engaged configuration.
B53. The safety brake of paragraph B52, wherein the solenoid armature is in direct physical contact with the brake assembly, or with the brake cam, as the actuator assembly transitions the brake assembly, or the brake cam, from the disengaged configuration to the engaged configuration.
B54. The safety brake of any of paragraphs B1-B53, wherein the safety brake further includes a deflection-mitigating structure.
B55. The safety brake of paragraph B54, wherein the deflection-mitigating structure is configured to resist deflection of the implement into contact with the brake assembly when the electric power tool is utilized to cut a workpiece and the brake assembly is in the disengaged configuration.
B56. The safety brake of paragraph B55, wherein the deflection-mitigating structure at least partially defines a/the implement-receiving region of the safety brake.
B57. The safety brake of any of paragraphs B55-B56, wherein the deflection-mitigating structure includes a deflection-mitigating surface configured to operatively contact the implement when the implement is deflected toward the brake assembly to resist deflection of the implement into contact with the brake assembly.
B58. The safety brake of paragraph B57, wherein the deflection-mitigating structure includes an electrically insulating structure configured to electrically insulate the deflection-mitigating structure from a remainder of the safety brake.
B59. The safety brake of any of paragraphs B1-B58, wherein the safety brake further includes a reset mechanism configured to permit a/the user of the electric power tool to selectively transition the brake assembly from the engaged configuration to the disengaged configuration.
B60. The safety brake of paragraph B59, wherein the reset mechanism includes an eccentric structure configured to operatively translate a/the brake cam of the brake assembly away from a/the implement-receiving region of the safety brake.
B61. The safety brake of any of paragraphs B59-B60, wherein the reset mechanism includes a pressure-actuated reset mechanism configured to at least one of:
(i) operatively translate a/the brake cam of the brake assembly away from a/the implement-receiving region of the safety brake; and
(ii) operatively translate a/the brake pad of the brake assembly away from the implement-receiving region.
B62. The safety brake of any of paragraphs B1-B61, wherein the brake assembly is configured to transition the brake assembly from the disengaged configuration to the engaged configuration in at least one of:
(i) at least 0.1 milliseconds (ms), at least 0.5 ms, at least 1 ms, at least 2 ms, at least 3 ms, at least 4 ms, or at least 5 ms; and
(ii) at most 10 ms, at most 9 ms, at most 8 ms, at most 7 ms, at most 6 ms, at most 5 ms, at most 4 ms, at most 3 ms, or at most 2 ms.
B63. The safety brake of any of paragraphs B1-B62, wherein the safety brake further includes an interlock assembly configured to:
(i) permit supply of electric current to a motor of the electric power tool when the safety brake is configured to selectively resist motion of the implement; and
(ii) block supply of electric current to the motor of the electric power tool when at least one component of the safety brake is not configured to selectively resist motion of the implement.
B64. The safety brake of paragraph B63, wherein the interlock assembly includes at least one of:
(i) a sensor status detector configured to indicate a status of a/the sensor assembly of the safety brake;
(ii) a brake assembly status detector configured to indicate a status of the brake assembly; and
(iii) an actuator assembly status detector configured to indicate a status of the actuator assembly.
C1. An electric power tool, comprising:
an implement holder configured to hold an implement, which is configured to perform an operation on a workpiece;
a motor configured to actuate the implement holder to move the implement; and
the safety brake of any of paragraphs B1-B64.
C2. The electric power tool of paragraph C1, wherein the electric power tool includes the implement.
C3. The electric power tool of any of paragraphs C1-C2, wherein the implement extends at least partially within a/the implement-receiving region of the brake assembly.
C4. The electric power tool of any of paragraphs C1-C3, wherein the power tool further includes at least one of:
(1) a gripping region configured to be gripped by a user of the power tool;
(ii) a switch configured to be actuated by the user of the power tool to initiate supply of electric current to the motor;
(iii) a power cord;
(iv) a battery; and
(v) a workpiece support configured to position a workpiece relative to the power tool.
C5. The electric power tool of any of paragraphs C1-C4, wherein the power tool includes at least one of:
(i) a saw;
(ii) a rotary cutting tool;
(iii) a fastening tool;
(iv) a reciprocating tool;
(v) a vibratory tool;
(vi) a woodworking tool;
(vii) a metalworking tool; and
(viii) an automotive tool.
C6. The electric power tool of any of paragraphs C1-C5, wherein the implement includes at least one of:
(i) a bit;
(ii) a blade;
(iii) a circular saw blade;
(iv) a socket;
(v) a grinding wheel;
(vi) a chain; and
(vii) a sanding pad.
C7. The electric power tool of any of paragraphs C1-C5, wherein the electric power tool is a circular saw, and further wherein the implement is a circular saw blade.
C8. The electric power tool of paragraph C7, wherein, when in the engaged configuration, the brake assembly is at least one of:
(i) free from engagement with teeth of the circular saw blade; and
(ii) spaced apart from the teeth of the circular saw blade.
C9. The electric power tool of any of paragraphs C7-C8, wherein the brake assembly is configured to operatively engage a planar side surface of the circular saw blade to resist rotation of the circular saw blade.
D1. A method of operating an electric power tool, the method comprising:
applying an electric current to a motor of the electric power tool;
responsive to the applying, moving an implement of the electric power tool;
during the moving, detecting an actuation parameter indicative of an undesired event to be avoided with the electric power tool; and
responsive to the detecting, transitioning a safety brake of the electric power tool from a disengaged configuration to an engaged configuration, wherein in the disengaged configuration, the safety brake permits motion of the implement, wherein in the engaged configuration, the safety brake resists motion of the implement, wherein the safety brake includes the actuator assembly of any of paragraphs A1-A31, wherein the solenoid drive circuitry is configured to generate the electrical impulse signal responsive to detection of the actuation parameter, and further wherein the transitioning includes providing the electrical impulse signal to the impulse solenoid to transition the impulse solenoid from the unactuated state to the actuated state.
D2. The method of paragraph D1, wherein the transitioning includes generating a/the magnetomotive force with the impulse solenoid of the actuator assembly.
D3. The method of any of paragraphs D1-D2, wherein the transitioning includes moving an/the solenoid armature through an/the armature range of motion.
D4. The method of any of paragraphs D1-D3, wherein, responsive to the detecting, the method further includes generating a trigger signal, which is provided to the actuator assembly, and further wherein the transitioning is responsive to the generating.
D5. The method of any of paragraphs D1-D4, wherein the actuator assembly includes any suitable structure, function, and/or feature of any of the actuator assemblies of any of paragraphs A1-A31.
D6. The method of any of paragraphs D1-D5, wherein the safety brake includes any suitable structure, function, and/or feature of any of the safety brakes of any of paragraphs B1-B64.
D7. The method of any of paragraphs D1-D6, wherein the electric power tool includes any suitable structure, function, and/or feature of any of the electric power tools of any of paragraphs C1-C9.
E1. The use, in an electric power tool, of an impulse solenoid to selectively transition a brake assembly from a disengaged state to an engaged state.
E2. The use of any of the actuator assemblies of any of paragraphs A1-A31, any of the safety brakes of any of paragraphs B1-B64, or any of the power tools of any of paragraphs C1-C9 with any of the methods of any of paragraphs D1-D7.
E3. The use of any of the methods of any of paragraphs D1-D7 with any of the actuator assemblies of any of paragraphs A1-A31, any of the safety brakes of any of paragraphs B1-B64, or any of the power tools of any of paragraph C1-C9.

### INDUSTRIAL APPLICABILITY

The power tools, safety brakes, and actuator assemblies disclosed herein are applicable to the power tool industry.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions, and/or properties disclosed herein. Similarly, when the disclosure, the preceding numbered paragraphs, or subsequently filed claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. (canceled)

2: A safety brake for an implement of an electric power tool, the safety brake including:
(i) a brake assembly configured to be transitioned between a disengaged configuration, in which the brake assembly permits motion of an implement, and an engaged configuration, in which the brake assembly resists motion of said implement; and
(ii) an actuator assembly configured to selectively provide a motive force to transition the brake assembly from the disengaged configuration to the engaged configuration, wherein the actuator assembly includes an impulse solenoid and solenoid drive circuitry, wherein the impulse solenoid is configured to be selectively transitioned from an unactuated state to an actuated state responsive to receipt of an electrical impulse signal, wherein the impulse solenoid is configured to provide the motive force while transitioning from the unactuated state to the actuated state, wherein the solenoid drive circuitry is configured to selectively generate the electrical impulse signal, and further wherein the electrical impulse signal has an impulse voltage of at most 43 volts (V) and is configured to transition the impulse solenoid from the unactuated state to the actuated state in a transition time of at most 15 milliseconds.

3: An electric power tool, comprising:
an implement holder configured to hold an implement, which is configured to perform an operation on a workpiece;
a motor configured to actuate the implement holder to move the implement; and
a safety brake according to claim 2.

4: The safety brake of claim 2, wherein the electrical impulse signal has an impulse duration of at most 10 milliseconds (ms).

5-6. (canceled)

7: The safety brake of claim 2, wherein the impulse solenoid includes an impulse coil configured to receive the electrical impulse signal and to generate a magnetic field responsive to receipt of the electrical impulse signal.

8: The safety brake of claim 7, wherein the impulse coil is at least partially defined by a wound wire, wherein the wound wire includes at least 10 wraps of wire and at most 120 wraps of wire, wherein the wire has a diameter of at least 0.3 millimeters (mm) and at most 1.5 mm, and/or
wherein the impulse coil has a time constant of at least 0.01 ms and at most 0.4 ms, and/or
wherein the impulse coil has a coil inductance of at least 0.01 millihenry (mH); and at most 0.44 mH.

9-12. (canceled)

13: The safety brake of claim 2, wherein the impulse solenoid includes a solenoid armature configured to operatively translate between an unactuated position and an actuated position as the impulse solenoid transitions between the unactuated state and the actuated state, wherein the solenoid armature defines an elongate axis, and further wherein the solenoid armature is configured to linearly translate along the elongate axis as the impulse solenoid transitions between the unactuated state and the actuated state.

14: The safety brake of claim 13, wherein the solenoid armature is configured to operatively engage the brake assembly to selectively apply the motive force to the brake assembly, and/or
wherein the solenoid armature has an armature mass of at least 1 gram (g) and at most 30 g, and/or
wherein the solenoid armature defines an armature range of motion between the unactuated position and the actuated position, wherein the armature range of motion is at least 0.5 millimeters (mm) and at most 10 mm.

15-16. (canceled)

17: The safety brake of claim 2, wherein the impulse solenoid further includes a biasing mechanism configured to at least one of:
(i) urge the impulse solenoid toward the unactuated state; and
(ii) transition the impulse solenoid from the actuated state to the unactuated state, subsequent to receipt of the electrical impulse signal by the impulse solenoid.

18: The safety brake of claim 2, wherein the impulse voltage is at least 10 V, and/or
wherein the impulse duration is at least 0.25 ms, and/or
wherein the solenoid drive circuitry is configured to generate the electrical impulse signal with an impulse current of at least 50 amps (A) and at most 1000 A, and/or
wherein the solenoid drive circuitry is configured to generate the electrical impulse signal with a current rise rate of at least one of at least 20,000 amps/second (A/s) and at most 1,000,000 A/s, and/or
wherein the solenoid drive circuitry is configured to have a duty cycle of at least 1*10\hat{ }-11 and at most 1*10\hat{ }-3, and/or
wherein the solenoid drive circuit includes a buffer circuit configured to selectively provide the electrical impulse signal.

19-24. (canceled)

25: The safety brake of claim 2, wherein the solenoid drive circuitry includes at least one of:
(i) a step-up converter configured to receive a power supply voltage from the electric power tool and to increase the power supply voltage to the impulse voltage, and
(ii) a step-down converter configured to receive the power supply voltage from the electric power tool and to decrease the power supply voltage to the impulse voltage.

26: The safety brake of claim 2, wherein the safety brake further includes a reset mechanism configured to permit a user to selectively transition the brake assembly from the engaged configuration to the disengaged configuration.

27: The safety brake of claim 2, wherein the brake assembly includes a brake cam configured to selectively transition between the disengaged configuration and the engaged configuration, wherein in the disengaged configuration, the brake cam is spaced apart from an implement-receiving region of the safety brake, that is configured to receive the implement, and in the engaged configuration, the brake cam extends into the implement-receiving region and is configured to operatively engage the implement and resist motion of the implement; and
wherein the actuator assembly is configured to selectively transition the brake cam from the disengaged configuration to the engaged configuration as the impulse solenoid transitions from the unactuated state to the actuated state.

28: The safety brake of claim 27, wherein the brake cam is configured to rotate about a cam axis of rotation to selectively transition between the disengaged configuration and the engaged configuration, wherein the implement-receiving region is an at least substantially planar implement-receiving region, and further wherein the cam axis of rotation is at least substantially parallel to the planar implement-receiving region, wherein the cam axis of rotation of the brake cam is at least substantially perpendicular to an actuation axis of the actuator assembly.

29. (canceled)

30: The safety brake of claim 27, wherein the brake assembly further includes a brake pad that includes a pad friction material, wherein the brake pad is positioned, relative to the brake cam, such that the pad friction material faces toward the brake cam,
wherein the brake pad is positioned, relative to the brake cam, such that the implement-receiving region of the safety brake extends at least partially between the brake pad and the brake cam, and/or
wherein the brake assembly is configured such that, when the brake cam is in the engaged configuration, the implement is compressed between the brake pad and the brake cam.

31-34. (canceled)

35: The safety brake of claim 27, wherein the brake assembly is a locking brake assembly configured to remain in the engaged configuration once the brake cam operatively engages the implement.

36: The safety brake of claim 2, wherein the safety brake further includes a sensor assembly configured to detect an actuation parameter and to generate a trigger signal responsive to detection of the actuation parameter, and/or
wherein the brake assembly is a resettable brake assembly configured to be selectively and repeatedly transitioned between the disengaged configuration and the engaged configuration, and/or
wherein the brake assembly is configured to transition the brake assembly from the disengaged configuration to the engaged configuration in at most 10 ms.

37.-39. (canceled)

40: The electric power tool of claim 3, wherein the electric power tool is a circular saw, and further wherein the implement is a circular saw blade, wherein the brake assembly is configured to operatively engage a planar side surface of the circular saw blade to resist rotation of the circular saw blade.

41.-42. (canceled)

43: A method of operating an electric power tool, the method comprising:
applying an electric current to a motor of the electric power tool;
responsive to the applying, moving an implement of the electric power tool;
during the moving, detecting an actuation parameter indicative of an undesired event to be avoided with the electric power tool; and
responsive to the detecting, transitioning a safety brake of the electric power tool from a disengaged configuration, in which the safety brake permits motion of the implement, to an engaged configuration, in which the safety brake resists motion of the implement, wherein the safety brake includes an actuator assembly configured to selectively provide a motive force for the transitioning, and further wherein the actuator assembly includes:
(i) an impulse solenoid; and
(ii) solenoid drive circuitry;
wherein the impulse solenoid is configured to be selectively transitioned from an unactuated state to an actuated state responsive to receipt of an electrical impulse signal;
wherein the impulse solenoid is configured to provide the motive force while transitioning from the unactuated state to the actuated state;
wherein the solenoid drive circuitry is configured to generate the electrical impulse signal responsive to detection of the actuation parameter; and
wherein the electrical impulse signal has an impulse voltage of at most 43 volts and an impulse duration of at most 10 milliseconds and is configured to transition the impulse solenoid from the unactuated state to the actuated state in a transition time of at most 15 milliseconds; and
further wherein the transitioning includes providing the electrical impulse signal to the impulse solenoid to transition the impulse solenoid from the unactuated state to the actuated state.

44: An actuator assembly configured to selectively provide a motive force to transition a brake assembly for an implement of an electric power tool from a disengaged configuration to an engaged configuration, the actuator assembly comprising:
an impulse solenoid, wherein the impulse solenoid is configured to be selectively transitioned from an unactuated state to an actuated state responsive to receipt of an electrical impulse signal and to provide the motive force while transitioning from the unactuated state to the actuated state, wherein the impulse solenoid includes:
(i) an impulse coil that is at least partially defined by wound wire and is configured to receive the electrical impulse signal and to generate a magnetic field responsive to receipt of the electrical impulse signal, wherein the wound wire includes at least 50 and at most 70 wraps of wire that has a diameter of at least 0.8 millimeters (mm) and at most 1 mm; and
(ii) a solenoid armature configured to operatively translate between an unactuated position and an actuated position as the impulse solenoid transitions between the unactuated state and the actuated state; and
solenoid drive circuitry configured to selectively generate the electrical impulse signal.

45: The actuator assembly of claim 44, wherein the electrical impulse signal has an impulse voltage of at most 43 volts and an impulse duration of at most 10 milliseconds and is configured to transition the impulse solenoid from the unactuated state to the actuated state in a transition time of at most 15 milliseconds, and/or
wherein the solenoid armature includes a pin and an anchor that is operatively attached to the pin, wherein the bin defines a rounded pin end that is configured to engage with the brake assembly, wherein the anchor defines an anchor diameter that is greater than a pin diameter of the pin.

46-53. (canceled)
